(19) United States
(12) Patent Application Publication
(10) Pub. No.: US 2024/0370098 A1
(43) Pub. Date: Nov. 7, 2024

(54) METHOD FOR DETECTING USER INPUT TO A BREATH INPUT CONFIGURED USER INTERFACE

(71) Applicant: PI-A CREATIVE SYSTEMS LTD, London (GB)

(72) Inventor: Luke HALE, London (GB)

(21) Appl. No.: 18/689,433

(22) PCT Filed: Sep. 7, 2022
(86) PCT No.: PCT/EP2022/074839

§ 371 Date: Mar. 6, 2024

(30) Foreign Application Priority Data
Sep. 7, 2021 (GB) 2112710.5
Sep. 7, 2021 (GB) 2112711.3

(51) Int. Cl. G06F 3/03; G06F 3/01; G06F 3/0482; G06F 3/16

(52) U.S. Cl. CPC G06F 3/0304; G06F 3/013; G06F 3/0482; G06F 3/165; G06F 3/167; G06F 2203/0381

(57) ABSTRACT

A computer-implemented method of breath input recognition, the method comprising an electronic device displaying a breath input enabled user interface, BIEUI on a display whilst in a breath input receiving state or operational mode, detecting, using a camera, a position of a head of a user of relative to the camera, determining, based on the detected position of the head of the user, if at least part of a face of the user is directed towards to the displayed BIEUI, detecting an audio signal using the microphone, and determining if the detected audio signal is an intentional breath input to the BIEUI based on the audio signal and the detected position of the head of the user.

### TECHNICAL FIELD

The present disclosure relates to a method of breath input recognition which detects when a user's breathe should be input to a breath input enabled user interface, BIEUI, and to various related aspects, including a method of training a user to provide breath input to a BIEUI, and to a BIEUI, for example, a BIEUI for text input.

In particular, but not exclusively the invention relates to a method of detecting when a breath of a user is an intentional input to a user interface presented on a display of a handheld device such as a smartphone or tablet or similar device having a microphone configurable to audibly detect a user's breathing and a camera configurable to detect at least a user's head position and orientation.

### BACKGROUND

The use of breath as a form of user input to a user interface is known, however, the use of breath as an enabler for a user to interact with a user interface is also known to have several drawbacks. In particular, wind and other environment sounds, including non-input breathing by the user or another person nearby, may unintentionally trigger selection of an affordance provided in BIEUI of an electronic device and so cause unwanted functionality to be performed by the electronic device. Repeatedly triggering unwanted functionality is frustrating to a user and also wastes energy and may use up other device resources as it may not be easy to simply undo the unwanted functionality in all circumstances, for example, if editing an email and a user selects “send” using breath input by mistake. This is problematic as breath user interfaces are particularly attractive to users who have motor skills problems who may not be able to utilise a conventional user interface provided on a touch screen of the device. It is also a problem for users to learn what sort of breath input may be accepted by a BIEUI, as the way that the BIEUI processes their breath is not necessarily intuitive.

### SUMMARY STATEMENTS

The disclosed technology seeks to mitigate, obviate, alleviate, or eliminate the issues known in the art. Various aspects of the disclosed technology are set out in this summary section with examples of some preferred embodiments.

A first aspect of the disclosed technology relates to a computer-implemented method of breath input recognition, the method comprising an electronic device: displaying a breath input enabled user interface, BIEUI on a display whilst in a breath input receiving state or operational mode; detecting, using a camera, a position of a head of a user of relative to the camera; determining, based on the detected position of the head of the user, if at least part of a face of the user is directed towards to the displayed BIEUI; detecting an audio signal using the microphone; and determining if the detected audio signal is a breath input based on one or more characteristics of the audio signal and the detected position of the head of the user to prevent unacceptable breath input to the BIEUI.

In some embodiments, determining if the detected audio signal is a breath input to the BIEUI based on the audio signal and the detected position of the head of the user comprises filtering the detected audio signal based on one or more characteristics of the audio signal and the detected position of the head of the user to prevent unacceptable breath input to the BIEUI, for example, using a filter, for example, a band pass filter to remove frequencies above SOOHz as audio signals in the Oto 500 Hz band have a high probability of being associated with airflow and breath. In some embodiments, the audio signal may be filtered in the sense of separating or sieving, or otherwise picking out, the breath signal based on characteristics of the audio signal (which may include a peak in band pass filtered audio) and detected position of the head.

Advantageously, by determining if the detected audio signal is a breath input to the BIEUI based on the audio signal and the detected position of the head of the user based not just on whether the audio characteristics indicate a candidate breath input to a BIEUI, but also dependent on the user's head position relative to the displayed BIEUI or microphone, validates that candidate breath as a probably breath input, unintentional, unauthorised and/or otherwise unacceptable audio input which could otherwise end up being treated as intentional breath input to the BIEUI is reduced. This also provides a reduction in the storage space required for any records comprising breath input to a BIEUI which are stored on or off the electronic device. By improving the BIEUI using the disclosed method, processing of erroneous breath inputs may be reduced and the resources of the electronic device, including energy resources, memory and computation resources as well as the time of the user which might otherwise be wasted processing unwanted breath input to the BIEUI can be saved. Another benefit of the disclosed technology is a lower likelihood of processing of non-breath input and/or non-intentional breath input (or non-authorized breath input). Processing such input as intentional breath input may cause unwanted interactions with a UI. This is frustrating and time-consuming for a user to correct, even if it is possible to undo. In some situations an “undo” may not be practical or possible, for example, if a user were to send an email or call the wrong number due to breath input being incorrectly detected triggering a “send” affordance or the wrong number in a telephone number etc.

In some embodiments, the determining if the detected audio signal is a breath input to the BIEUI based on the audio signal and the detected position of the head of the user comprises: determining one or more audio characteristics of an audio signal using the microphone; determining if the audio signal comprises a BIEUI candidate breath input based on one or more the detected audio characteristics and the detected position of the head of the user, wherein, responsive to a determination that the detected audio signal comprises a BIEUI candidate breath input, the candidate breath input is provided as intentional breath input to the BIEUI; and responsive to a determination that the detected audio signal does not comprise a BIEUI candidate breathe input, discarding the unacceptable candidate breath input and/or processing the microphone input as non-breath audio input.

In some embodiments, the method further comprises authenticating the user for intentional breath input to be acceptable intentional breath input to the BIEUI.

In some embodiments, the method further comprises determining if a type of breath input matches a type of breath input the displayed BIEUI is configured to receive for intentional breath input to be acceptable intentional breath input to the BIEUI.

In some embodiments, the method further comprises: guiding a cursor or other movable selection indicator presented in the BIEUI to a selectable BIEUI affordance; and confirming using breath input selection of the selectable BIEUI affordance.

In some embodiments, the cursor is guided by tracking a position of the head of the user using at least the camera.

In some embodiments, the cursor is guided by tracking a gaze position of the user using at least the camera.

In some embodiments, determining, based on the detected position of the head of the user, if at least part of a face of the user is directed towards to the displayed BIEIUI comprises determining a location (position x, y, z or distance to the device) of the head relative to the camera or display or microphone and determining an orientation of a face of a user relative to the display or relative to the orientation of the electronic device.

In some embodiments, the distance is determined based on a consistent point of reference such as the display of the device but in some embodiments, it is assumed that the camera is mounted near the display and the distance is measured to the display/camera. The position from the camera is known, and the user's face and facial features which are measured by the camera may be measured using the camera. This allows a position to the display, microphone or any other consistent reference point for position measurements on the device to be inferred providing the relation between camera and device/mic is known. This means that in some embodiments, determining optimum positions for breath input to be detected as intentional breath input the dimensions, location of components and/or screen size of the display of the device is also used. In some embodiments, the device and/or display orientation, for example, whether a user is holding the device in landscape or portrait mode is also determined, as this may also alter the relative position between a component such as the camera and/or microphone and the display providing the BIEUI.

In some embodiments, determining if the audio signal comprises a BIEUI candidate breath input based on one or more the detected audio characteristics and the detected position of the head of the user comprises determining a probability of breath input is higher than a breath detection threshold, wherein the breath detection threshold is based on detecting audible breath input and one or more of a detected head position being indicative of a user facing the display, the position of the head being within a certain distance of the device, and a mouth area of the user being above a threshold mouth area value.

In some embodiments, the breath detection threshold is a calibrated threshold for the user based on a spatial mapping of audio using the camera and microphone which calibrates a detected characteristic of the audio signal to that of a spirometry value.

In some embodiments, the determining if the detected audio signal is a breath input to the BIEUI based on the audio signal and the detected position of the head of the user determines if a BIEUI candidate breath input is a BIEUI breath input based at least in part of a magnitude of the detected audio signal, and the method further comprises combining, using a multivariate model, the camera input and microphone input, wherein the distance and/or orientation of the face of the user from the displayed BIEUI determined from the camera input is used to adjust the magnitude of the audio signal detected by the microphone.

In some embodiments, the determining if the detected audio signal is a breath input to the BIEUI based on the audio signal and the detected position of the head of the user determines if a BIEUI candidate breath input is a BIEUI breath input based at least in part on an area of a mouth of the user, and the method further comprises: determining one or more facial characteristics of the user, determining from the one or more facial characteristics a mouth area of the user, wherein if the mouth area of the user is determined to be below a threshold value, the audio signal is determined to not correspond to intentional breath user input.

In some embodiments, the method further comprises: wherein the method further comprises: performing facial recognition of the detected face of the user to authenticate the user, wherein, responsive to the facial recognition indicating a user is a non-authenticated user, determining the detected audio signal is a breath input from an unauthenticated user and comprises unacceptable intentional breath input to the BIEUI.

In some embodiments, the method further comprises: wherein the method further comprises: performing facial recognition of the detected face of the user to authenticate the user, wherein, responsive to the facial recognition indicating a user is a non-authenticated user, the method comprises determining the detected audio signal is an breath input from an unauthenticated user and comprises unacceptable intentional breath input to the BIEUI.

In some embodiments, the method further comprises displaying an image of the face of the user concurrent with detecting an audio signal using the microphone, and displaying an overlay of augmented reality elements on the display to guide the user to change one or more of: a distance of the face of the user from the microphone; a position and/or orientation of the head of the user affecting a direction of breath from the user; a device orientation relative to gravity or relative to the orientation of the head of the user; and one of more characteristics of at least a part of the head of the user affecting a magnitude of the detected breath signal from the user.

In some embodiments, the electronic device enters the breath input receiving state responsive to detecting a triggering breath input to a BIEUI.

A second aspect of the disclosed technology relates to a computer-implemented method for training a user to provide breath input acceptable by a breath input enabled user interface, BIEUI, the method comprising on an electronic device: displaying a breath input training BIEUI, detecting audio input, determining one or more characteristics of the detected audio input, determining a conformance of one or more characteristics of the detected audio input with corresponding one or more characteristics of a predetermined type of intentional breath input to the breath input training BIEUI, and causing at least one visual indicator of the conformance to be presented in the breath input training BIEUI.

The embodiments of the disclosed method of breath input recognition advantageously provides technical information related to how the electronic device has detected the user's breath which might not otherwise be available to a user unless they were operating the device in a developer mode. Accordingly, by implementing the training method, a user is able to receive visual feedback relating to how their breath input is being detected which allows them to improve the breath input to the electronic device and/or to better operate the electronic device and access functionality using a BIEUI. This may also reduce unwanted BIEUI responses to breath input by a user.

In some embodiments, a breath input to a breath input enabled user interface, BIEUI, is equivalent to a corresponding type of touch input on a touch user interface. A breath input may be considered equivalent to a tap. Different types of breath input may correspond to different touch or gesture based input. For example two breath inputs in quick succession may be considered to be equivalent to a double tap, a long breath to a long press etc. Breath is not recognised as a “right kind” of breath input, in the same way there is not a “right kind” of tap, but a breath pattern is able to add other functionality, just like a gesture based input does, for example, like pinching or a long press works on a touchscreen.

By using a camera together with a microphone input to detect when a user is providing breath input allows intentional breath input to be interpreted with far more fidelity for the actual user intent to interact with a specific UI elements such as affordances. Embodiments of the invention assist a user in to provide breath input which is optimally detected. This may result in a far more intuitive user experience and may result in a higher probability of a user's intended breath input being detected. IT may also reduce falsely interpreting microphone input as a breath input.

Another benefit of the disclosed technology is that the method of breath input recognition works to maximise the intuitiveness of a breath interface, which reducing the amount of effort the user has to put in to use, i.e. it is as sensitive and accurate as possible, and may be provided as an application on conventional electronic hardware devices such as, for example, smartphone hardware.

In some embodiments, determining the conformance comprises performing a method of breath input recognition according to an embodiment of the first aspect, wherein audio input which fails to conform with the one or more characteristics of the predetermined type of intentional breath input to the BIEUI is determined to be a non-intentional breath input which is not provided as breath input to the BIEUI.

In some embodiments, determining the conformance comprises performing a method of breath input recognition according to the first aspect, wherein audio input which conforms with the one or more characteristics of the predetermined type of intentional breath input to the BIEUI is provided as breath input to the BIEUI.

In some embodiments, the at least one visual indicator of the conformance comprises causing presentation of a graphical element comprising an animated graphic or UI element, the animated graphic or UI element comprising at least one foreground or background graphical element.

In some embodiments, the method further comprises: modifying the at least one foreground or background graphical element by changing one or more visual characteristics of the foreground or background graphical element based on a score indicative of the conformance.

In some embodiments, the modification of the at least on foreground graphical element comprises one or more of:
tracing a shape outline on the display, direction and speed at which the shape outline is traced is determined in real-time based on a score indicative of the conformance;
filling a shape outline presenting on the display, wherein the speed at which the shape outline is filled is determined in real-time based on a score indicative of the conformance.

In some embodiments, the at least one visual indicator of the conformance comprises causing presentation of an animated graphic, or UI element comprising one or a combination of one or more of the following, either sequentially or as a combination: tracing a shape outline on the display, wherein the direction and speed at which the shape outline is traced is determined in real-time based on a score indicative of the conformance; filling a shape outline presenting on the display, wherein the speed at which the shape outline is filled is determined in real-time based on a score indicative of the conformance; and modifying at least one dynamic background graphical element, wherein one or both of the direction and speed of the dynamic background graphical element is based on a score indicative of the conformance.

In some embodiments, instead or in addition to a visual graphical element being presented based on the degree of conformance in any of the embodiments of the method according to the second aspect, the method instead or in addition comprises: causing at least one visual indicator comprising an animated graphic, or UI element to be presented on a display to provide guidance on one or more of: one or more of the user's breath input characteristics, the user's head position and/or orientation, the electronic device's position and/or orientation.

In some embodiments, the visual indicators are generative and are not repeating as they are created in real-time in response to the breath input.

In some embodiments, the electronic device is configured guide a user to position their head for optimal breath detection, and the method further comprises providing a visual indicator in a user interface of the electronic device to guide the user to align a yaw and pitch of that user's face to orientate that user's mouth towards a location of a microphone or other breath sensing element(s) of the electronic device.

In some embodiments, the electronic device is configured to guide a user to position their head for optimal breath detection, and the method further comprises providing a visual indicator in a user interface of the electronic device to guide the user to position their head at a distance or within a range of distances from the device.

In some embodiments, the method comprises providing the visual indicator to guide the user in a breath input enabled user interface, BIEUI.

By providing visual feedback to a user, the user is made aware of how they can optimally align their head position and/or orientation so as to increase the probability of intentional breath being detected by the electronic device and provided as acceptable breath input to a breath enabled user interface. In some embodiments, guidance is different for different types of breath input. For example, visual indicators are provided for a long exhalation input which are different for different types of input. For example, they will be different for long breath exhalations than for a short breath exhalation input or double short breath exhalation input.

These visual indicators for conformance and for position and yaw and pitch are generative and are not repeating as they are created in real-time in response to the breath input.

In some embodiments, instead or in addition to any visual feedback in real time being provided by any of the above mentioned visual indicators, audio feedback may be provided in the form a generation of a MIDI sequence comprising one or more of: an arpeggiation, pitch, chord changes, audio volume, low or high pass filtering, starting note, scale type or interval, length of MIDI sequence, and oscillator parameters/synthesiser parameters such as, for example, waveform, attack, sustain, decay, release etc., generation of noise, for example, white/pink/red/purple or grey noise.

In some embodiments of the conformance indicators, instead or in addition to the speed at which a shape outline is filled, visual feedback in real time may be provided by changing a displayed UI foreground or background element to indicate a change in one or more of: position, velocity, a degree or intensity of colour, colour gradients, scale, opacity, deformation, expansion/contraction, attraction/repulsion, rotation, iteration step (in a convolution kernel e.g. for cellular automata), simulation parameters such as, for example, gravity, viscosity, or virtual wind force, for example, for fluid, soft body, rigid body simulations, 3D virtual camera position.

In some embodiments, the score is dependent on at least the detected magnitude of the audio input.

A third aspect of the disclosed technology relates to an apparatus comprising memory, one or more processors, and computer program code stored in the memory, wherein the computer program code, when loaded from memory and executed by the one or more processors causes the apparatus to perform a method according to at least one embodiment of the first aspect.

A fourth aspect of the disclosed technology relates to an apparatus comprising memory, one or more processors, and computer program code stored in the memory, wherein the computer program code, when loaded from memory and executed by the one or more processors causes the apparatus to perform a method according to at least one embodiment of the second aspect.

In some embodiments, the apparatus comprises a handheld electronic device comprising at least a camera, a microphone and a display. For example, the electronic device may comprise a smart phone or a tablet or the like.

In some embodiments, the apparatus of one or more of the third or fourth aspects comprises means or one or more modules of computer code to perform a method according to one or more of the first or second aspects.

A fifth aspect of the disclosed technology relates to a computer program comprising a set of machine executable instructions, which, when loaded and executed on apparatus, for example an apparatus according to the third aspect, causes the apparatus to perform a method according to the first aspect.

A sixth aspect of the disclosed technology relates to a computer program comprising a set of machine executable instructions, which, when loaded and executed on apparatus, for example an apparatus according to the fourth aspect, causes the apparatus to perform a method according to the second aspect.

The machine executable instructions may comprise computer code executed in hardware and/or software.

The computer program may be stored in non-transitory memory.

The disclosed aspects and embodiments may be combined with each other in any suitable manner which would be apparent to someone of ordinary skill in the art.

### BRIEF DESCRIPTION OF THE DRAWINGS

Some embodiments of the disclosed technology are described below with reference to the accompanying drawings which are by way of example only and in which:

FIG. 1 schematically illustrates an example scenario where a user's breath is input to a breath input enabled user interface displayed on an electronic device having a breath detection module according to some embodiments of the disclosed technology;

FIG. 2 schematically illustrates in more detail the example embodiment illustrated in FIG. 1;

FIG. 3A illustrates schematically how the pitch and yaw positions of a user's face relative to an image sensor mounted on an electronic device is measured by the electronic device according to some embodiments of the disclosed technology;

FIGS. 3B to 3D illustrate schematically how the electronic device of FIG. 3A may be configured guide a user to align the yaw and pitch of a user's face to orientate the user's towards the location of the microphone to provide acceptable breath input to a breath enabled user interface;

FIGS. 3E to 3H illustrate schematically how the electronic device of FIG. 3A may be configured to guide a user to correctly position a distance of a user's face relative to an image sensor provided on an electronic device to provide acceptable breath input to a breath enabled user interface;

FIG. 4A illustrates schematically an example face detected by an image sensor;

FIGS. 4B to 4E illustrate schematically examples of facial characteristics which may be determined from the face detected in FIG. 4A;

FIG. 5A illustrates schematically an example method for recognising breath input to a breath enabled user interface according to some of the disclosed embodiments;

FIG. 5B illustrates schematically another example method for recognising breath input to a breath enabled user interface according to some of the disclosed embodiments;

FIG. 5C illustrates schematically an example of a system for performing a method of breath input recognition according to some of the disclosed embodiments;

FIGS. 6A to 6E illustrate schematically examples of where implementation of a method of recognising a breath input reduces a false breath input to a breath input enabled user interface according to the disclosed technology;

FIGS. 7A to 7J illustrate schematically an example embodiment of text input to a breath input enabled user interface according to some of the disclosed embodiments;

FIGS. 8A and 8B illustrate schematically another example of a breath input enabled user interface;

FIG. 9 illustrates schematically how the keyboard of FIGS. 8A to 8C may be reconfigured according to some embodiments of the disclosed technology;

FIGS. 10A and 10B illustrate schematically two other examples of a breath input enabled user interface for text according to some embodiments of the disclosed technology;

FIGS. 11 and 12A illustrate schematically how a probability of a user's breath being determined to be breath input to a breath enabled user interface may be dependent on a distance of a user's mouth from a breath input sensor according to the some of the disclosed embodiments;

FIG. 12B illustrates schematically an example of how the probability of a user's breath being input may be dependent on the directional input of breath according on a yaw orientation of a user's mouth relative to the position of a breath input sensor according to the some of the disclosed embodiments;

FIG. 12C illustrates schematically an example of how the probability of a user's breath being input may be dependent on the directional input of breath according on a pitch orientation of a user's mouth relative to the position of a breath input sensor according to the some of the disclosed embodiments;

FIGS. 13A and 13B illustrate schematically an example of how the probability of a user's breath being input may be dependent on the orientation of an electronic device and the position of a breath input sensor relative to a user's mouth according to the some of the disclosed embodiments;

FIGS. 14A and 14B illustrate schematically another example of how the probability of a user's breath being input may be dependent on the orientation of an electronic device and the position of a breath input sensor relative to a user's mouth according to the some of the disclosed embodiments;

FIGS. 15A to 15C illustrate schematically an example of how the probability of a user's breath input may be dependent on the user's mouth area according to the some of the disclosed embodiments;

FIGS. 16A to 16E show how a user's position may be presented to a user when an electronic device is performing an embodiment of a method of training a user to provide breath input according to any of the disclosed embodiments;

FIG. 17A shows schematically an alternative way of indicating how a user's position by an embodiment of a method of training a user to provide breath input according to any of the disclosed embodiments;

FIG. 17A shows schematically another alternative way of indicating how a user's position by an embodiment of a method of training a user to provide breath input according to any of the disclosed embodiments;

FIG. 18 illustrates schematically an example screenshot sequence in a breath input enabled user interface configured to train a user to provide a breath input to a breath input enabled user interface input by exhaling;

FIG. 19 illustrates schematically an example screenshot sequence in a breath input enabled user interface configured to train a user to provide a breath input to a breath input enabled user interface input by holding their breath in or out;

FIG. 20 illustrates schematically an example screenshot sequence in a breath input enabled user interface configured to train a user to provide a breath input to a breath input enabled user interface input by holding their breath in or out;

FIGS. 21 to 24 each illustrate schematically other examples of screenshots sequence in a breath input enabled user interface configured to train a user to provide a breath input to a breath input enabled user interface input by exhaling;

FIG. 25 illustrates schematically a method performed by an electronic device to provide a breath input enabled user interface for training a user to provide user interface acceptable breath input according to some of the disclosed embodiments;

FIG. 26 illustrates schematically a method performed by an electronic device to provide a breath input enabled user interface for selecting text according to some of the disclosed embodiments;

FIG. 27A illustrates schematically an example electronic device on which some of the disclosed method embodiments may be performed;

FIG. 27B illustrates schematically an example memory of the example electronic device of FIG. 27A holding computer-code which when executed causes the electronic device to implement one or more methods according to some of the disclosed embodiments; and

FIG. 28 illustrates schematically how a spatial map of breath input magnitude may be created for calibrating the electronic device according to some of the disclosed embodiments.

### DETAILED DESCRIPTION

Aspects of the present disclosure will be described more fully hereinafter with reference to the accompanying drawings. The apparatus and method disclosed herein can, however, be realized in many different forms and should not be construed as being limited to the aspects set forth herein. Steps, whether explicitly referred to a such or if implicit, may be re-ordered or omitted if not essential to some of the disclosed embodiments. Like numbers in the drawings refer to like elements throughout.

The terminology used herein is for the purpose of describing particular aspects of the disclosure only, and is not intended to limit the disclosed technology embodiments described herein. As used herein, the singular forms “a”, “an” and “the” are intended to include the plural forms as well, unless the context clearly indicates otherwise.

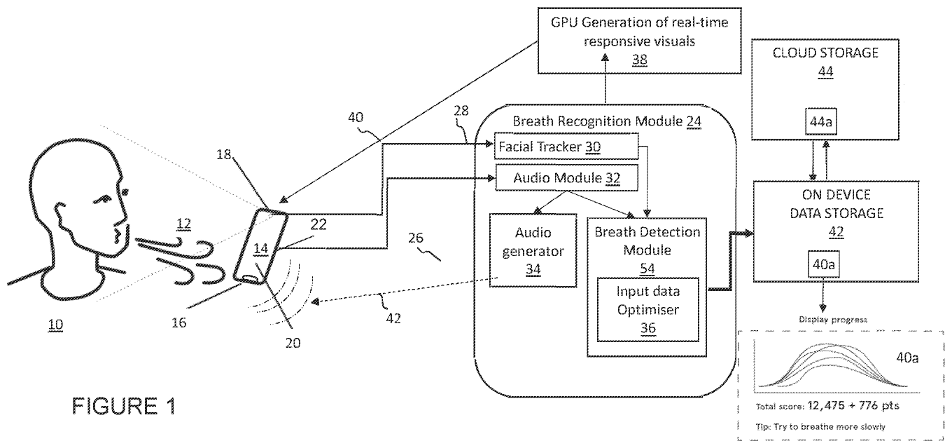

FIG. 1 schematically illustrates an example of user 10 providing audio input 12 by breathing into a microphone 16 of a device such as an electronic device 14. The electronic device 14 also includes a front-facing camera 18 with a field of view, FoV, which allows capture of a head of the user. In some embodiments the electronic device 14 comprises a handheld device such as a smart phone or tablet or the like and the FoV of the camera 18 is then configured to include at least the user's head when the user is holding the electronic device 14 at a distance suitable for providing breath input as an audio input to microphone 16. In other embodiments, the device 14 may not be handheld when in use and displaying a BIEUI in which case the FoV may be configured to capture a user's head when the user is with a preferred proximity of the microphone input, in other words, when the user's mouth is not too far and not to close to the microphone.

Some embodiments of device 14 are configured be in a breath input standby receiving state so as to be able to accept breath input to trigger presentation of a breath input enable user interface, BIEUI, 20 on a display 22 of the device 14. In some embodiments of device 14, however, instead or in addition the device 14 accepts breath input when the electronic device is already in a breath input receiving state and presenting a BIEUI. It is also possible for display 22 to be an external display which the device 14 is configured to provide graphical output to in some embodiments.

When the electronic device 14 is causing display of a breath input enabled user interface, BIEUI, 20 on display 22 the electronic device 14 is configured to respond to breath input 12 to directed to an affordance 50, such as an icon or menu option for example, of the user interface 18 by actuating that affordance 50 to trigger its associated functionality. However, as microphone input which could otherwise be interpreted as breath input can come from a number of sources (e.g. environmental, wind, etc.), a BIEUI application 70 uses a breath input recognition module 24 according to the disclosed embodiments to perform a method of breath input recognition to determine which microphone data is intentional and acceptable breath input and which is not intentional and not acceptable breath input. In other words, a user may provide breath input 12 but it is only if the raw microphone data 26 generated by that breath input 12 has one or more characteristics which conform to a set of one or more breath input conditions that their breath will from a breath input accepted by the BIEUI. Example of characteristics that the raw microphone data may need to have include a frequency spectrum that is determined using a suitable model, for example, a machine learning model such as a convolutional neural network, CNN, based model or a recurrent neural network, RNN, may be used. An example of a CNN model which may be adapted to monitor a user for breath input is the model disclosed in “A machine learning model for real-time asynchronous breathing monitoring” by Loo et al, IFAC PapersOnline 51-27 (2018) 378-383. Other examples are mentioned, for example, in “Implementation of Machine Learning for Breath Collection” by Santos P., Vassilenko V., Vasconcelos F. and Gil F., DOI: 10.5220/0006168601630170 In Proceedings of the 10th International Joint Conference on Biomedical Engineering Systems and Technologies (BIOSTEC 2017), pages 163-170 ISBN: 978-989-758-216-5 The machine learning model or any other model takes the microphone audio data and analyses it to determine a confidence score that the microphone audio signal data was generated by breath input by comparing it with a data set of audio signal data associated with intentional breath input. In some embodiments, the ML model or other model used for analysis of the audio input signal 26 may determine or a magnitude of one or more sound frequencies in the audio input 26 which is/are above threshold level(s) for intentional breath input. Candidate breath input determined by the audio module is then provided to a breath detection module 54 for validation using data from a head and face detector module 30. Face detector 30 is a facial position detector which determines the distance and orientation of the user's face relative to the displayed BIEUI 20 based on the relative orientation of the user's face to the orientation of the display screen 20 of the device 14.

In this manner, the BIEUI may become more energy efficient as a user is able to navigate the BIEUI by selecting any affordances presented by the BIEUI with fewer false inputs. As each incorrect activation of an affordance may require additional interactions to activate, for example, a back affordance and subsequent correct affordance selection, by reducing the number of input errors which might otherwise occur from erroneous breath input energy can be saved and user frustration reduced as graphical elements such as affordances can be selected more rapidly which also means a user may navigate within a user interface more rapidly. The embodiments of a method of breath input recognition disclosed herein may potentially be even more useful when user breath input is intended to be a confirmatory input when a cursor element is being moved over a displayed BIEUI towards an affordance which the user intends to select, for example by using a head position tracker, gaze tracker, or brain-machine interface, as by preventing false selection of any other affordances which lie along the path taken by the cursor based on breath input which falsely confirms an unwanted affordance or the like, the user interface can be displayed for less time, and this allows the display 20 of the user interface to save energy resources and also involve less user time and physical effort.

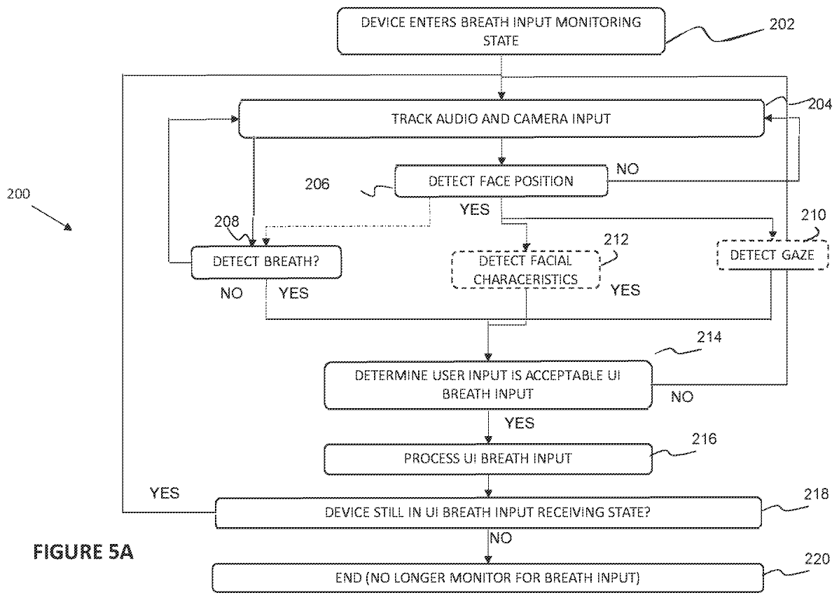

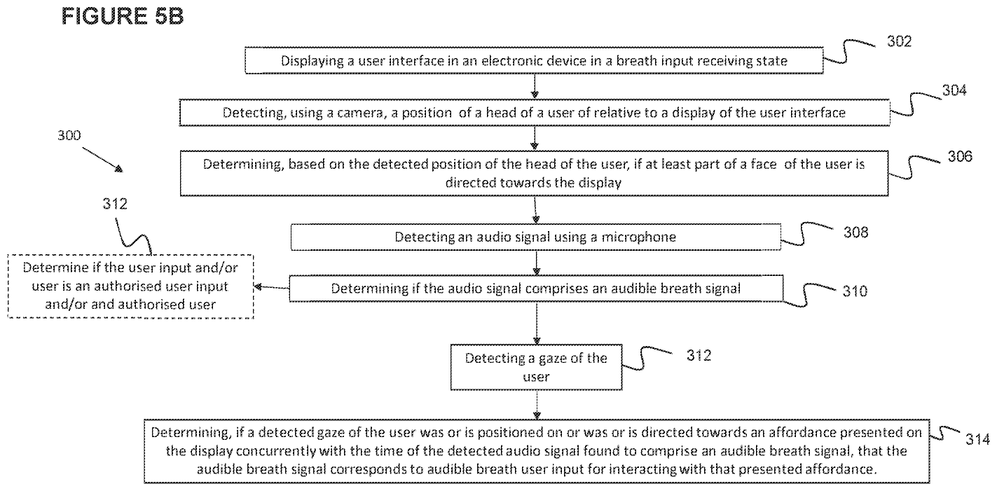

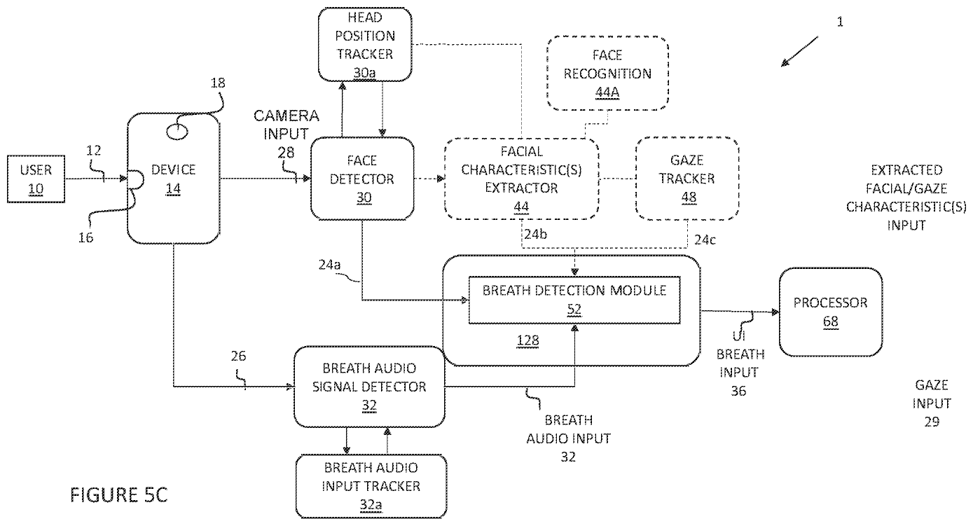

The device 14 shown in FIG. 1 is an example of an electronic device 14 configured to perform a computer-implemented method of breath input recognition according to an embodiment of the first aspect such as, for example, the method 300 illustrated in FIG. 5C and described in more detail later below. For example, some embodiments of the computer-implemented method 300 comprise a method of detecting breath user input comprising, for example whilst the device 14 is displaying a BIEUI 20, detecting, using a camera 18, a position of a head of a user 10 relative to camera 18, determining, based on the detected position of the head of the user 10, if at least part of a face of the user is directed towards the display, detecting an audio signal using a microphone, determining if the audio signal comprises an audible breath signal, and, if the face of the user is determined to be directed towards the display concurrent with a determination that an audio signal comprises an audible breath signal, determining the audible breath signal corresponds to audible breath user input.

Another embodiment of the method of breath input recognition comprises an electronic device: displaying a breath input enabled user interface, BIEUI on a display whilst in a breath input receiving state or operational mode; detecting, using a camera, a position of a head of a user of relative to the camera; determining, based on the detected position of the head of the user, if at least part of a face of the user is directed towards to the displayed BIEUI; detecting an audio signal using the microphone; and determining if the detected audio signal is a breath input to the BIEUI based on the audio signal and the detected position of the head of the user. Unacceptable breath input may include unintentional or erroneous breath input and/or unauthorised breath input in some embodiments.

In some embodiments, the above method is performed whilst both the electronic device and the BIEUI are in a breath input receiving state.

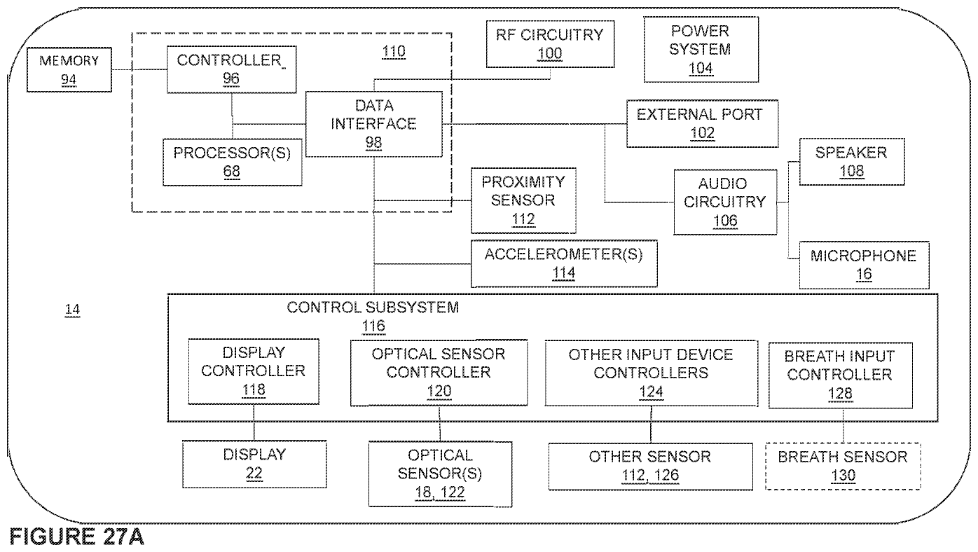

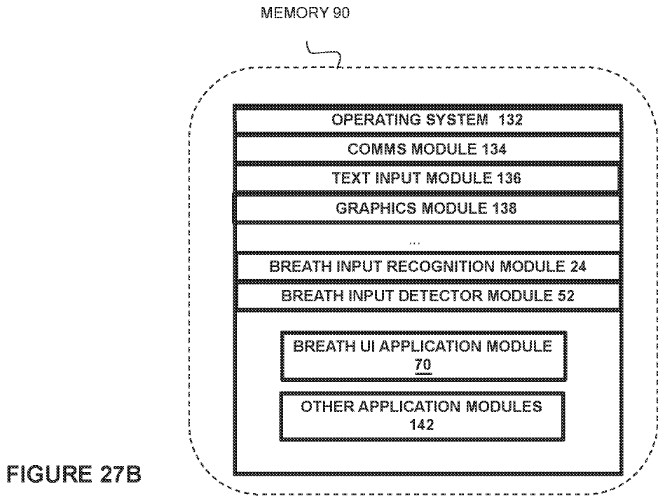

In FIG. 1 the electronic device 14 is configured to accept breath input via a suitable breath input device 16 such as, for example, a microphone, a breath sensor or air pressure sensor or other suitable breath input device or sensor 130 (see FIG. 27A). A camera 18 or other image or optical sensor 122 provides camera input 28 to a breath recognition module 24 which validates the microphone input 26 using a facial tracker 30 which is configured to perform face detection on the camera input 28 and by using an audio module 32 which is configured to process the microphone input 26 for intentional breath input.

As illustrated in FIG. 1, breath recognition module 24 also comprises an audio generator 34 which is capable of generating audio feedback and/or audio output 42, for example, music, sounds and digitised speech may be output in some embodiments. The breath recognition module 24 also comprises a breath input data optimizer 36 which processes the output of the facial detector/tracker 30 and audio module 32 to optimize when microphone input 26 comprises an intentional breath input. The optimized data output may be stored on the device 14, for example, in a memory 94 (see FIG. 27A) or in a suitable type of other on-board data storage 42. Data representing breath input may also be stored on a remote data storage device in the form of an anonymised data record 44a in some embodiments. Remote access to anonymised breath input data records 44a may also be provided in some embodiments, for example, for clinicians to access patient data.

The breath recognition module 24 shown in FIG. 1 is also configured to provide output to a graphical processor or processors or other processors 38 (not shown in FIG. 1) unit which may generate in real-time visual graphics 40 to guide a user interacting with a BIEUI according to some of the disclosed embodiments. Examples of real-time visual graphics which may be presented in a BIEUI on device 14 include a cursor or similar input indicator such as a change of emphasis, colour or highlight, of a displayed graphical element in the BIEUI where the position of the cursor (which term shall refer herein to any equivalent positional indicator which is presented in a UI) whose position on a displayed BIEUI may be changed by a user, for example, by using their gaze. A cursor however may not be needed if the UI does not comprise a plurality of selectable affordances as a breath input will automatically select a UI which at any one time presents only one affordance for breath input.

FIG. 1 also shows an example of a graphical output 40a from the breath recognition module 24 which comprises a graph and/or numeric values along with text to guide a user to provide better breath input.

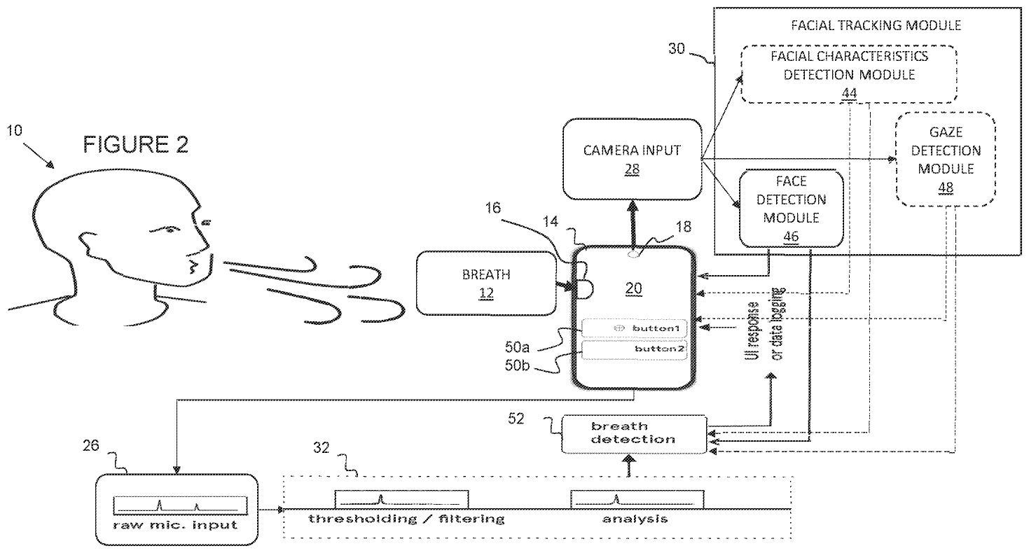

FIG. 2 schematically illustrates in more detail the way various components of an example electronic device 14 may be configured using a breath recognition module 24 to implement a method of breath input recognition 300 according to any of the disclosed embodiments. In some embodiments, the microphone 16 provides raw microphone audio input 26 to an audio module 32 which performs signal amplitude thresholding to remove background noise, or, for example, very quiet breathing input which might not originate from the user of the device, and frequency filtering to remove unwanted audio frequencies above the 500 Hz band which are less likely to include candidate breath input and/or performs other data analysis, for example, using a suitable ML or AI model to determine if the audio input 26 feed may include breath input. The output is provided as input to a breath detection module 52 which processes the detected audio signal based on one or more characteristics of the audio signal output by the audio module 32 and based on the output of the face tracking module 30 indicating a detected head position of the user to remove unintentional and/or unacceptable breath input to the BIEUI 20. Unacceptable breath input includes unintentional breath input which may not be of a type which the BIEUI can accept and/or which is determined to originate from an unauthorised user.

In some embodiments, the electronic device 14 uses the breath detection module 52 to determine one or more audio characteristics of an audio signal using the microphone and if the audio signal comprises a BIEUI candidate breath input based on one or more the detected audio characteristics and the detected position of the head of the user, provides the candidate breath input as input to the BIEUI as intentional user input. If instead, the detection module determines the detected audio signal does not comprise a BIEUI candidate breathe input, the microphone input 26 may be discarded on the basis it is not acceptable breath input to BIEUI and/or processed as non-breath audio input.

The detected head position of the user is provided using a camera 18 such as may be found on an electronic device such as a smartphone, tablet, watch or the like, but may also be determined in some embodiments instead or in addition by using one or more image sensors 122 such as other optical or infra-red sensors 122 are configured to feed images in the form of video data input to facial tracking module 30. The image sensors may also comprise depth image sensors configured to determine a distance of an imaged object from the image sensor sensing the object, such as are well known in the art.

As shown in FIG. 2, in some embodiments, facial tracking module 30 comprises a face detection module 46 configured to automatically process the video feed from the camera 18 and any other image sensors 122 to attempt detection of a user's face and head position whenever audio signals are detected using microphone 16 when the electronic device 14 is in a breath input enabled state and displaying a BIEUI 20 on display 22.

FIG. 2 also shows an example BIEUI 20 comprising a plurality of affordances 50a, 50b on a display 22 of the device 14. A user is able to interact and select one of the affordances 50a, 50b using a suitable type of breath user input and/or other input, however, it will be apparent that more or less affordances may be provided in other examples of BIEUIs. By way of example, an affordance 50a may provide an indication to a user to select it by providing a short breath input whereas affordance 50b may provide an indication to a user to select it by providing a long breath input. In some embodiments, instead or in addition to the affordance being selectable using different types or patterns of breath input, a cursor may be guided to the correct location for a breath input to select a particular affordance or any other selectable element presented on the UI by monitoring or tracking a user's head position, facial features and/or the user's gaze.

The face tracking module 30 is triggered automatically whenever the camera is activated by the breath input recognition module 24 so that any raw microphone input 26 can be processed, for example, to pattern match it or band pass filter out unwanted frequencies, so as to determine how probable it is that the raw microphone input 26 comprises intentional user breath input to the BIEUI 20. Raw microphone data 26 which is not determined to be breath input is not subject to further processing by the breath input recognizing module 24 in some embodiments which results in the BIEUI 20 remaining in a standby or idle state waiting for input. This saves unnecessary computational resources from being used to process and/or activating the BIEUI 20 in error.

In some embodiments, breath recognition module 24 is configured to always activate the camera whenever the electronic device 14 enters a breath input receiving state. The electronic device 14 may enter a breath input receiving state whenever it starts up or resumes a different operational mode from a standby operational mode in some embodiments. In some embodiments, however, instead, the device 14 enters the breath input receiving state whenever an application is launched which has a BIEUI.

In some embodiments, device 14 also comprises a facial characteristics detection module 44, for example, the facial characteristics module may perform facial recognition to authenticate a user as an additional validation step for any detected breath input. The facial characteristics detection module 44 may be configured to perform facial recognition by extracting facial characteristics from the camera input either directly as shown or via the face detection module 46, also referred to here as face detector 46.

In this manner, microphone audio input may be validated as breath input to a BIEUI by a breath controller module 52. The execution of the breath controller module 52 provides at least part of the functionality shown in FIG. 27A of the a breath input controller 128. The breath input controller 128 and breath controller module 52 may comprise coded instructions which, when executed by the electronic device 14, cause the electronic device to a method of breathe input recognition according to any one or more of the disclosed embodiments. In some embodiments, the microphone data is processed to remove unvalidated breath input and retains validated, intentional, breath input. To be validated at least a part of a face is been detected however, in some embodiments, additional indicators that the audio signal provided as input from the microphone is intended user breath input may be required. If an audio input signal from the microphone is not validated as breath input, it may be discarded or treated as microphone input.

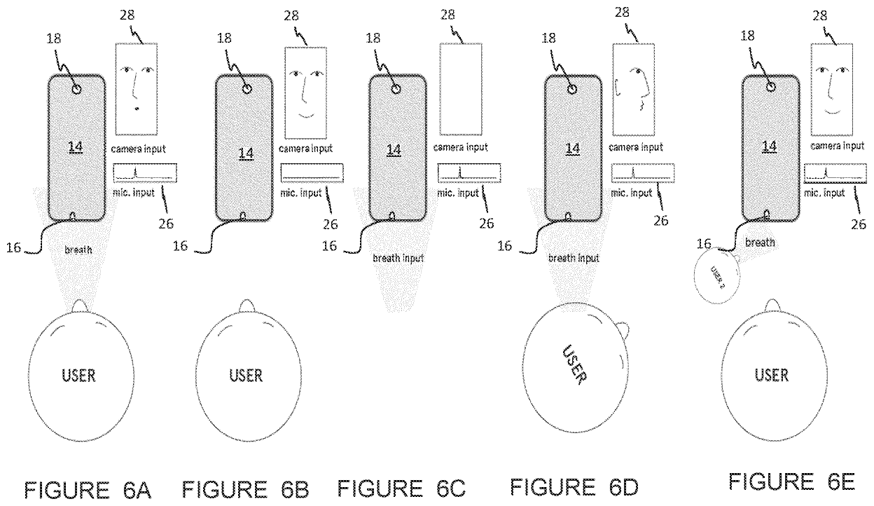

The embodiments of the method of recognising breath input disclosed herein may use a variety of different sources to validate microphone input as breath input. In some embodiments, the method uses a combination of the characteristics of audio data from a microphone and characteristics of image data from a camera indicating a user's face has been detected to determine when an audio feed from a microphone comprises audio input which is not breath input and to validate when the audio feed from the microphone does comprise breath input which is likely to be intentional breath input to the BIEUI. FIGS. 6A to 6B described in more detail below illustrate schematically examples of how a method of breath input recognition may be used to eliminate false negatives, which may arise from inputs from the user as well as unintentional inputs from one or more other users as well as the external environment generating noise which could erroneously be considered breath input, for example, wind noise, animal noise etc. For example, unintentional breath input by a user may comprise input generated any time there is a signal on the microphone which could be interpreted as breath input that they are not intending; e.g. speaking; Other sources of false negatives may include in addition to environmental sources such as wind, fans, background noise etc., potentially non-authenticated users.

In some embodiments, the display 22 comprises a touchscreen display, however, it is also possible to interact with a user interface presented on an external display connected to the electronic device in some embodiments, for example, an external display may be connected wirelessly or in a wired fashion, to an external monitor or television screen, either directly or via an intermediate device. As an example, a user may provide breath input to a smartphone such as an Apple iPhone, which may be configured to project a mirrored user interface via an external periphery such as an Apple TV device to an external television or monitor. Other examples of electronic device 14 however may include stand-alone terminals such as may be commonly found in train stations for obtaining travel tickets, registering for doctors ‘appointments, and displays which may be integrated into other apparatus including domestic appliances such as refrigerators or the like. In some embodiments, instead of device 14 including a microphone and a display, a headset could be worn which includes a microphone which is to be used with display which may comprise a near-eye display or a remote display such as a television or smartphone or tablet, or computer monitor or the like. In some embodiments, the device 14 may comprise a watch or wearable either alone or in conjunction with another device. The watch or wearable device may include just a microphone 16 but may also comprise a display 22 on which a BIEUI is presented.

In some embodiments, a breath input application may be provided on any suitable electronic apparatus having a camera and a microphone and processing power sufficient to implement the breath input application when presenting a breath input user interface.

FIG. 2 shows schematically the way a breath input application is used by the electronic device 14 of FIG. 1. As shown in FIG. 1B, the breath input 12 of the user is detected using a microphone 16 of an electronic device 14 when the device 14 is displaying a breath input enabled user interface 20 comprising at least one affordance 50 for triggering functionality on the electronic device 20, for example, two affordances 50a, 50b, are illustrated as button 1 and button 2 in FIG. 2. In FIG. 2, the raw microphone output is provided as input 26 to an audio module 32 the output of which is fed into a suitable data analysis model for analysis in order to determine when the raw microphone input represents a breath audio signal intended by the user to be breath input to the user interface 20. In some embodiments, the data analysis model comprises a suitably trained ML model, however, in some embodiments, a statistical or other form of suitable model known in the art may be used. When breath is detected, its characteristics are processed by the breath detection module 52 and the output of the breath detection module 52, if the breath input is a breath input recognized for the displayed UI affordances 50a, 50b, triggers the functionality the selected affordance is associated with. In some embodiments, to reduce the amount of energy used monitoring for any intentional UI breath input, the electronic device 14 is configured to provide the camera output as input 28 to a face detection module 46 of a face tracking module 40. By using a face detection module 46 to trigger the capture of breath audio data and its subsequent processing by, for example, the trained ML model when a face has been detected, energy may be saved compared to when the device is always processing microphone input to determine if breath is a user interface intended input breath.

In some embodiments, the camera output 28 may also be provided to a facial characteristics detection module 44, which may be configured to recognize a user based on the camera input indicating facial characteristics corresponding to a known user being matched with a certain degree of confidence. In some embodiments, the output 28 of the camera may accordingly also be used to authenticate a user when the user is providing an intentional breath user input, i.e., dynamically.

In some embodiments, a user's gaze may be tracked by a gaze detection module 48 also receiving camera input 28. Advantageously gaze tracking allows a user to select from a plurality of presented UI affordances 50 using their gaze and to confirm the gaze selection using their breath. Accordingly, in some embodiments, the user interface presents a plurality of affordances on the display and in order to determine which affordance or user interface element a user wishes to interact with, a user's gaze is tracked to guide a cursor to over a selectable affordance, which can then be selected by the user providing a suitable breath input.

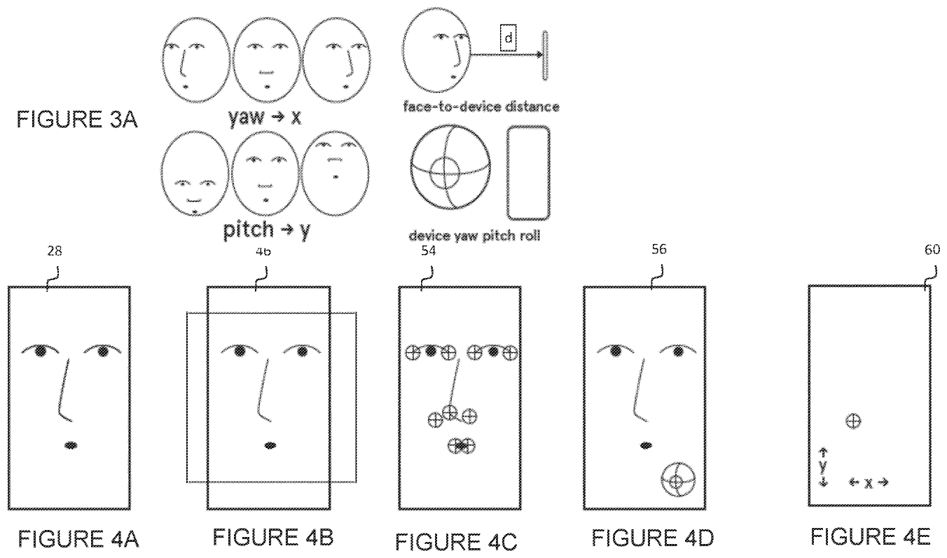

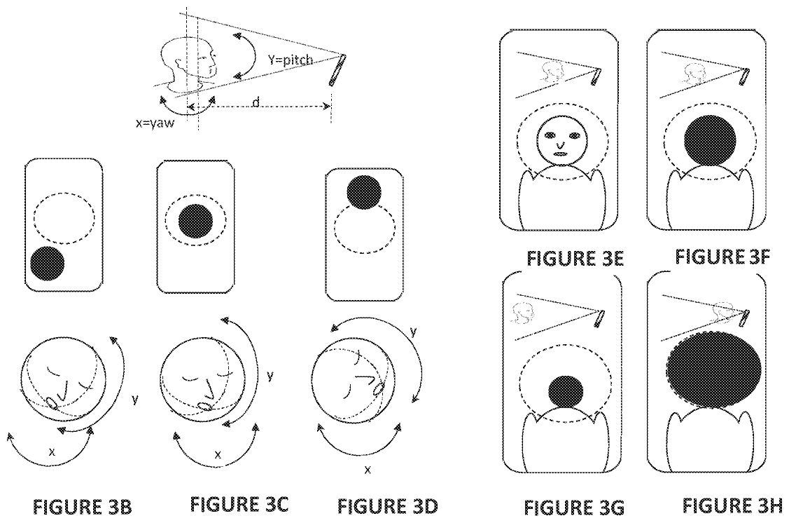

FIG. 3A illustrates schematically how the pitch and yaw positions of a user's face relative to an electronic device 14 configured to perform a method of breath input recognition, such as a method according to any of the disclosed embodiments according to the first aspect and/or a method of providing input using a dynamic keyboard breath input enabled user interface, BIEUI, such as a method according to any of the disclosed embodiments of the second aspect. In some embodiments, the position may be determined using, for example, an image or depth sensor mounted on the electronic device. The pitch and yaw are measured in some embodiments to reduce the discrepancy between the user's detected pitch/yaw and the pitch yaw determined for optimum breath input, for example, for use in a method according to the second aspect disclosed here which relates to a computer-implemented method for training a user to provide breath input acceptable by a breath input enabled user interface, BIEUI. The pitch and yaw may be measured as zero from a neutral position, but this is not standardised and reducing to pitch yaw to zero may not be the optimum for breath input in some embodiments of the disclosed technology. Many smart phones and similar electronic devices are provided with depth sensors along with optical sensors which can be used to determine a distance, d, of a user's face to the device. In FIG. 3A, the top left hand side image shows schematically how the side to side orientation or yaw of a user's face is determined relative to the camera imaging it using the raw camera input (see FIG. 4A) firstly by facial detection (see FIG. 4B), then by determining and tracking landmark facial features (see FIG. 4C) found by performing facial feature tracking. The up/down or vertical orientation shown in the bottom left hand side of FIG. 3A is referred to herein as the pitch of the user's face. The pitch may also be determined using facial feature tracking of landmark features. The face to device distance, d, is indicated by the top right-hand side of FIG. 3A. The face-to-device distance may be the closest surface of the user's face to a proximity or depth sensor of the electronic device 14 in some embodiments. A typical distance for an audio signal from microphone 16 to be determined as intentional breath input, is likely to be less than Im. Less than 10 cm however, it is less likely and more than 1 more is less likely. In addition, for example, to determine the facial orientation of the user relative to the imaging camera or sensor 18. FIG. 3A shows in the lower right hand side of the figure that the device yaw, pitch and roll is measured as well, for example, by using an accelerometer or the like in order to determine the relative face position of the user to the displayed BIEUI 20 on the screen 22 on or associated with device 14. FIGS. 3B to 3D illustrate schematically in more detail how the electronic device 14 may be configured guide a user to position their head for optimal breath detection, for example, to align the yaw and pitch of a user's face to orientate the user's mouth towards the location of the microphone 16 or other breath sensing element(s) of the device. By optimally aligning the user's head position and/or orientation the probability of intentional breath being detected and provided as acceptable breath input to a breath enabled user interface is increased. In some embodiments, for example, if the pitch and yaw are measured from zero in a neutral position, the discrepancy between the user's detected pitch/yaw and the pitch yaw determined for optimum breath input will be reduced, however, as this is not standardized, reducing the pitch and yaw to zero may not be the optimum for breath input in all embodiments.

FIGS. 3E to 3H illustrate schematically how the electronic device of FIG. 3A may be configured to guide a user to correctly position a distance of a user's face relative to an image sensor provided on an electronic device to provide acceptable breath input to a breath enabled user interface, BIEUI.

Returning to FIG. 4A, as mentioned above, this shows schematically an example face detected by an image sensor of an electronic device 14 such as camera 18. FIGS. 4B to 4E illustrate schematically examples of facial characteristics which may be determined from the face detected in FIG. 4A. FIG. 4D shows schematically how the user's head/face orientation, gaze tracking, and or the device orientation may be taken into account when determining facial characteristics of the user associated with an intentional breath input to a BIEUI. FIG. 4E shows schematically an example of a reference co-ordinate system which may be used by the electronic device 14 to implement an embodiment of the method of breath recognition.

FIG. 5A illustrates schematically a process 200 which an electronic device 14 performs to recognise breath input to a breath enabled user interface according to some of the disclosed embodiments. In FIG. 5A, the electronic device enters 202 a breath input monitoring state which may be automatically triggered whenever a BIEUI is caused to be displayed on the electronic device. This also triggers a camera 18 or similar optical or other type of image sensor 122 to generate a video feed which is then tracked 204 to detect a user's face. If a face is detected 206 then the device checks of it has also detected 208 user breath input. In some embodiments, detection of a user's breath will trigger the camera to check for a face and in some embodiments, as indicated by the dash-dot-dash line in FIG. 5A, the camera will automatically generate a video feed so that face detection can be performed when a BIEUI is being displayed. In some embodiments, in addition to face detection the electronic device 14 detects and/or otherwise determines 212 facial characteristics if a face is detected. The device may also, optionally, detect 210 a user's gaze to determine how a cursor or similar input selection indicator may be moved on the screen. If the user input is determined to be acceptable input to a BIEUI 214, then the audio signal detected using the microphone 16 of the electronic device 14 is processed as accepted UI breath input 216. The electronic device will then, if remains in a BIEUI enabled state, in other words in a breath input receiving state 218, continue to track audio and camera input 204. However, if the electronic device 14 is no longer in a UI breath input receiving state 218, it will cease to monitor audio input for breath input to a BIEUI.

In some embodiments, the breath audio signal detector 32 and the face detector 30 are to run the electronic device 14 however, in some embodiments, the electronic device may access equivalent functionality via a communication link established between the device 14 and one or more remote host platforms, for example, a cloud-based service may be used to provide the breath audio signal detector and/or the face detector 20.

FIG. 5B illustrates schematically another example embodiment of a method 300 of breath input recognition which detects when audio signals detected using a microphone of an electronic device comprise breath input to a breath input enabled user interface, BIEUI, displayed on the device. In FIG. 5B, the example embodiment of method 300 comprises displaying a user interface in an electronic device in a breath input receiving state 302, detecting, using a camera, a position of a head of a user of relative to a display of the user interface 304, determining, based on the detected position of the head of the user, if at least part of a face of the user is directed towards the display 306, detecting an audio signal using a microphone 308, determining if the audio signal comprises an audible breath signal 310, optionally, determining if the user input and/or user is an authorised user input and/or and authorised user 312 and/or detecting a gaze of the user 312 directed at the displayed BIEUI, and determining, 314, if a detected gaze of the user was or is positioned on or was or is directed towards an affordance presented on the display concurrently with the time of the detected audio signal found to comprise an audible breath signal, that the audible breath signal corresponds to audible breath user input for interacting with that presented affordance.

FIG. 5C illustrates schematically an example of a system 1 for performing a method of breath input recognition according to some of the disclosed embodiments, for example, a method of breath detection according to the first aspect and/or as illustrated in FIG. 5A or 5B.

In FIG. 5C, a user generates an audio input 26 by breathing 12 into a microphone 16 of a device 14 such as an electronic device. The audio input is provided as raw input to a breath audio signal detector 32 which may track the audio input using a breath audio input tracker 32a. The audio detector or module 32 may suitably remove unwanted frequencies from the audio input signal 26, for example, it may use thresholding and also perform band-pass filtering to remove frequencies above 500 Hz as breath input is more likely to be detected in the 0-500 Hz frequency band. Other forms of signal analysis may also be performed to determine if the audio input 26 comprises candidate audio breath input. The candidate breath input is the provided to the breath detection module 52 of the breath input controller 128. The breath detection module 52/breath controller 128 may then validate the candidate breath input using the input from at least the face detector 30, and may also obtain input from a facial characteristics tracker, so as to determine a probability score for the candidate breath input to be an intentional breath input. If the probability of the candidate breath input is sufficiently high, the candidate breath input may be validated as an intentional breath input.

The face detector 30 obtains a feed from the camera and/or any other image sensors to detect if a face is present within the FoV of the camera at a time which is concurrent with when the microphone has detected the audio input. This can be done, for example, by comparing timestamp or similar timing information. The face detector 30 will determine landmark features for the face and uses these, possibly with depth input indicating the distance of the user's head from the camera, to track the users head position using a head position tracker 30a.

Optionally, in some embodiments the face detector 30 includes or communicates with a facial characteristic(s) extractor 44 which may in some embodiments perform facial recognition to authenticate a user when breath input is provided to the BIEUI. In some embodiments, the face detector also or instead includes and/or communicates with a gaze tracker 48 which is configured to detect the user's gaze direction relative to objects such as affordances displayed in the BIEUI 30 on the display 22.

The output 24a of at least the face detector to the breath detection module 52 is used to determine a probability that the breath input is a valid, i.e., intentional breath input to the BIEUI. For example, the probability may be determined in some embodiments using a weighted probability score, P, which is dependent on the detected face orientation relative to the electronic device 14, PI, and a “A”, a device orientation weigh factor/importance indicator. Optionally one or more other weights and factors may be taken into account, for example, a weighting factor “B” for a probability which depends on a detected distance “d” of the device to the user's face, and probability score P3 could depend on an orientation of the microphone 16 of the device 14 such as whether it is facing up or down in some embodiments and be weighted by a factor C. In some embodiments, accordingly, if PI, P2, and P3 etc. are different probabilities of the microphone input 26 comprising candidate breath input, the total probability may be given by a linear combination of the different probabilities, with the weighting factors adding to 1.0 in some embodiments, so that if the total Probability=API+BP2+CP3 is greater than a threshold, the microphone input is taken as breath input. Other factors which may be used to determine the probability of an audio signal comprising an intentional breath input to a BIEUI include distance, head orientation, device orientation, and mouth area. A combination of these factors may be weighted appropriately and summed to provide an overall probability score.

By way of example, if P1=75% chance of breath input with face orientation and A, the weighting factor is 0.6 to reflect the degree of importance given to orientation, and P2=80% for distance, with “B” the weighting factor being 0.4 then alpha*PI+beta*P2=breath input probability, then 0.6*0.72+0.4*0.8=0.77, meaning there is a 77% chance of breath input, and if the threshold is set at 70%, the microphone audio signal input 26 would be interpreted as candidate breath input, and, absent any requirement for the breath input to be of a particular type or for the user to be authenticated, the candidate breath input would then be provided as acceptable breath input to the BIEUI. This is a simple scoring model, however, as would be known in the art, a machine learning model with these parameters could instead be used to determining the probability of microphone input forming a breath input.

The breath controller module 128 then determines if the valid breath input is an acceptable breath input for the displayed BIEUI. For example, a user's breath may be correctly determined to be an acceptable breath input, however, if the only affordance indicated by the BIEUI requires a double breath within a predetermined period of time, then the breath input will not be accepted as input by the BIEUI. Similarly, by way of example, if a double breath within the predetermined period of time was detected, the breath input may also require the user's face to be recognised for that breath input to be accepted as being an authenticated user input to the BIEUI.

In some embodiments, a breath input is determined to be acceptable based on the output 24a of the face tracker indicating a face is detected at a distance within a predetermined range of distances from the device 14. This measurement may be performed using a depth camera as camera 18 and/or by using a proximity sensor 112 (see FIG. 128). Proximity sensors and depth cameras are now included in many electronic devices such as smartphones and tablets, and accessing their functionality is well known in the art. In some embodiments, output 24a also includes data indicating the orientation of a detected face of relative to the displayed BIEUI. If the BIEUI is displayed on a display 22 of an electronic device 14 such as a smartphone or tablet, this will be the orientation of the user's face relative to the display of the electronic device 14. Examples of suitable smartphones and other types of electronic devices such as a tablet on which a method of breath input recognition or any of the other methods disclosed herein include, for example, an Apple iPhone such as the iPhone 12 Pro or iPhone 12 Pro Max, or the Apple iPad Pro 2020, for example on iOS 12.0 or later versions, which all include a LIDAR sensor, or an Android device such as a Samsung Galaxy S20 Ultra which has a time-of-flight sensor, which can be adapted for detecting a head of a user and other facial characteristics etc. However, in some embodiments, the device 14 does not have a depth or proximity sensor, in which case, the distanced is determined using the camera image input and microphone input. The depth (i.e. distance to face), is determined in some embodiments accordingly by measuring the interpupilary distance on the camera image of a user's pupils, providing the focal length of the camera and the image sensor size or the field of view, FoV are known. However, the use of a depth camera and/or proximity sensor may be used in some embodiments to determine depth more quickly and/or more accurately.

In some embodiments, the output 24a includes position data for the user's head which are tracked using the head position tracker 30a to move a cursor or similar selection indicator in the BIEUI so that a user can select an affordance or similar UI element presented in the BIEUI using a confirmatory breath input. In some embodiments, however, instead or in addition, gaze tracker 48 provides gaze tracking information 24c to the breath detection module 52. In some embodiments, an output 24c of the facial characteristics extractor 44 and/or face recognition 44A is also provided to the breath input controller 118 and/or the breath detection module 52 to determine if a detected breath input is an acceptable breath input for the displayed BIEUI.

The head position determined using the head tracker 30a may be provided in any suitable set of coordinates, for example, the position may be provided as xyz co-ordinates relative to the device 14 within the FoV of camera 18 or by a single proximity metric such as a depth measurement, or distance measurement d, as shown in FIG. 3A.

The orientation of the user's face is based on landmark features which are detected using any suitable technique known in the art to provide facial feature detection. For example, landmark features may include relative positions of eyes, nose, and mouth which can be used to determine a pitch, yaw, and, in some embodiments, a roll of a user's head, for example, see Arcoverde, Euclides & Duarte, Rafael & Barreto, Rafael & Magalhaes, Joao & Bastos, Carlos & Ing Ren, Tsang & Cavalcanti, George. (2014). Enhanced real-time head pose estimation system for mobile device. Integrated Computer Aided Engineering. 21. 281-293. 10.3233/ICA-140462. In some embodiments, this information may also or instead be provided by suitably paired device in communication with the breath detection module such a headset or near eye display or the like.

In some embodiments the facial characteristic extractor 44 is configured to extract facial features such as depth, mouth area, facial orientation, gaze and the like, and provide a set of one or more parameters representing one or more facial characteristic(s), such as, for example, distance, orientation, expression, mouth area within threshold, to the breath input detector 52 and/or breath controller 128.

These characteristics can be used to calibrate the breath input for example, and/or to provide more accurate or more nuanced user input, so that instead of just the breath input being detected or not, it is possible to provide a particular type or strength of user breath input. Examples of different types of user input include long breath, short breathes, focused breath in a particular direction, for example, directed at a particular element of a displayed user interface on device 14. Training a user to provide breath input of a recognised type, for example, how a “double breath” should be provided may be implemented using a breath training BIEUI configured to perform a method of according to another, for example, the second, aspect of the invention.

The output of the breath input controller module 128 comprises accepted breath input 36 which is then processed by the electronic device, for example, by using one or more processors 68. Processors 68 are configured to cause the electronic device to perform functionality responsive to the received breath input depending on the specific configuration of the BIEUI 20 associated with the received breath input.

FIGS. 6A to 6E illustrate schematically example scenarios where the method of breath detection may be implemented to reduce the number of false positive breath inputs.

FIG. 6A shows schematically a breath UI input detection event where a face has been detected and the probability of breath input is high, accordingly the detected breath as a candidate breath input to the user interface.

FIG. 6B shows schematically no breath UI input detection event as there is no breath signal despite a face having been detected, the probability of breath input is low, accordingly there is no detected breath and so no candidate breath input to the user interface.

FIG. 6C shows schematically when there is no face detected and the probability of breath input is very low, and accordingly the detected breath as a candidate breath input to the user interface.

FIG. 6D shows schematically a breath UI input detection event when the user is not facing the microphone but instead their head is oriented away from the microphone 16. Although a face has been detected, the probability of breath input is low, accordingly even though there is a detected breath there is no candidate breath input to the user interface.

FIG. 6E shows schematically another example where a face has been detected but the facial expression and mouth area are not consistent with breath input and so the probability of breath input is also low, accordingly although a breath has been detected, the detected breath is not a candidate breath input to the user interface.

By recognising breath input more reliably using an embodiment of the disclosed method of breath input recognition, more affordances can be provided in a BIEUI for a user to make a selection from more quickly rather than the user having to navigate a more hierarchical BIEUI. For example, the above mentioned method of recognising breath input, or any another breath input recognition technique, can be used in conjunction with a dynamic keyboard UI to provide a more efficient form of alpha-numeric text input, or input of another type of graphical element, such as an emoji or symbol, which would otherwise require a user to navigate between the static elements of a keyboard. A benefit of the dynamic keyboard affordance arrangement is a reduction in the amount of time a user may need to guide a cursor to a desired affordance, in other words, the extent to which a user has to move their head/eyes/or touch to get to the intended button compared to a qwerty keyboard or conventional layout is reduced.

Another aspect of the disclosed technology comprises a computer-implemented method of providing input using a dynamic keyboard breath input enabled user interface, BIEUI, the method comprising an electronic device 14: causing a keyboard affordance arrangement of selectable affordances of the BIEUI, to be presented on a display, wherein each selectable affordance is associated with a functionality performed by the electronic device which is triggered if the affordance is selected, detecting a cursor movement to a selectable affordance in the affordance arrangement; detecting an breath input to the BIEUI, triggering, responsive to a determination that the detected breath input has been accepted by the BIEUI, a selection of that selectable affordance of the affordance arrangement, wherein the selection of that selectable affordance causes performance of the keyboard functionality associated with the affordance selection indicated by the cursor and updating of the displayed keyboard affordance arrangement to display changes in position of at least one affordance in the keyboard dependent at least in part on a probability of functionality associated with each changed at least one affordance following the functionality triggered by the selected affordance.

In some embodiments, updating the keyboard affordance arrangement changes a position of at least one affordance in the keyboard affordance arrangement displayed in the BIEUI. Updating the keyboard affordance arrangement may cause at least one new affordance associated with a new functionality to be presented in the keyboard affordance arrangement displayed in the BIEUI. Updating the keyboard affordance arrangement may cause at least one previously displayed affordance to be removed from the keyboard affordance arrangement displayed in the BIEUI. The at least one removed affordance may be the previously selected affordance and/or be a different affordance from the selected affordance.

The functionality triggered by the selection of an affordance from the keyboard affordance arrangement causes a graphical element to be presented in a text input box of the BIEUI, for example, a graphical element which is one or more of an alpha-numeric character, a word or phrase, an image, a symbol and/or an emoji. An ASCII character in a particular font and font size is also an example of a graphical element, which includes grammatical characters such as “.”, “/”, and “?” and the like.

In some embodiments, accordingly, the keyboard affordance arrangement comprises an arrangement of affordances indicating graphical elements, wherein each graphical element comprises one or more text characters and the functionality associated with the selection of an affordance comprises providing the selected text character as input to the text input field presented in the BIEUI. Updating the keyboard affordance arrangement changes the text characters in the affordance arrangement. The updated keyboard affordance arrangement comprises affordances associated with text characters having a position in the keyboard affordance arrangement based on an estimated likelihood of each of their associated text characters following the previously selected text character displayed in the text input field.

In some embodiments, the BIEUI may be a user interface comprising a three dimensional interface in which case, instead of minimising distance in x, yon a planar interface, the distance between elements in a spatial interface i.e. x, y, z is minimised. A BIEUI may then provide a dynamically updatable keyboard affordance comprising a lattice of cubes or spheres in some embodiments, with the next probable input being positioned in three dimensions closest to the user.

The BIEUI interface dynamic keyboard arrangement may also be provided in non-BI EUI interfaces where a spatial distance between successively selected affordances is minimized for other forms of user input selection, such as in a brain-machine user interface for example.

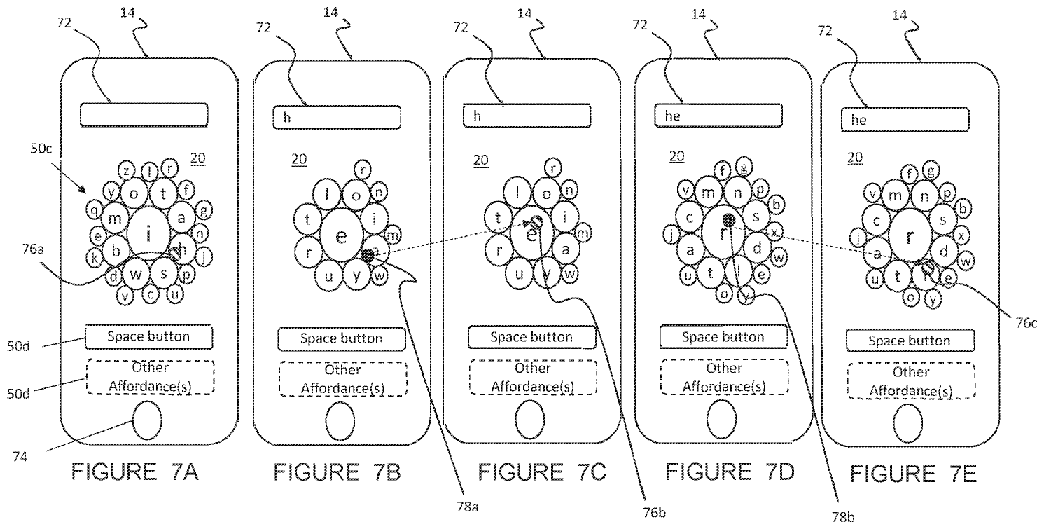

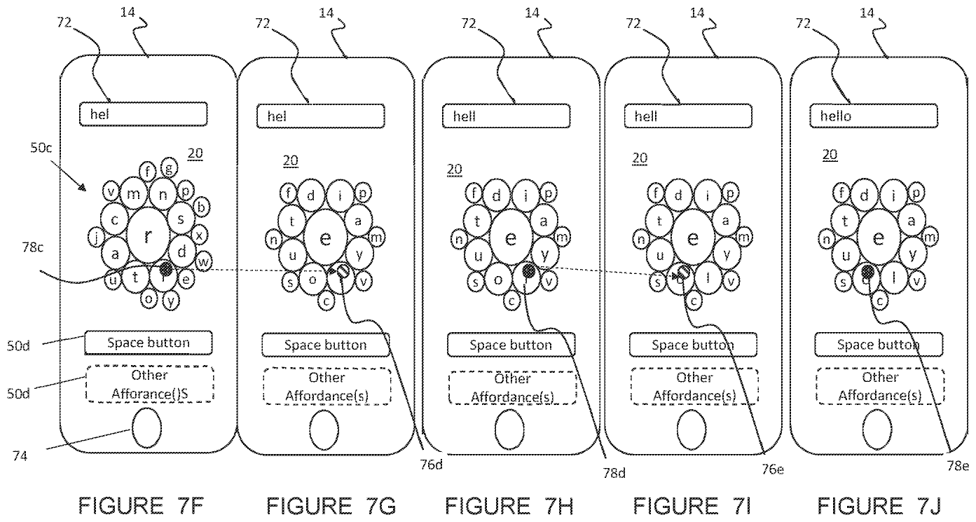

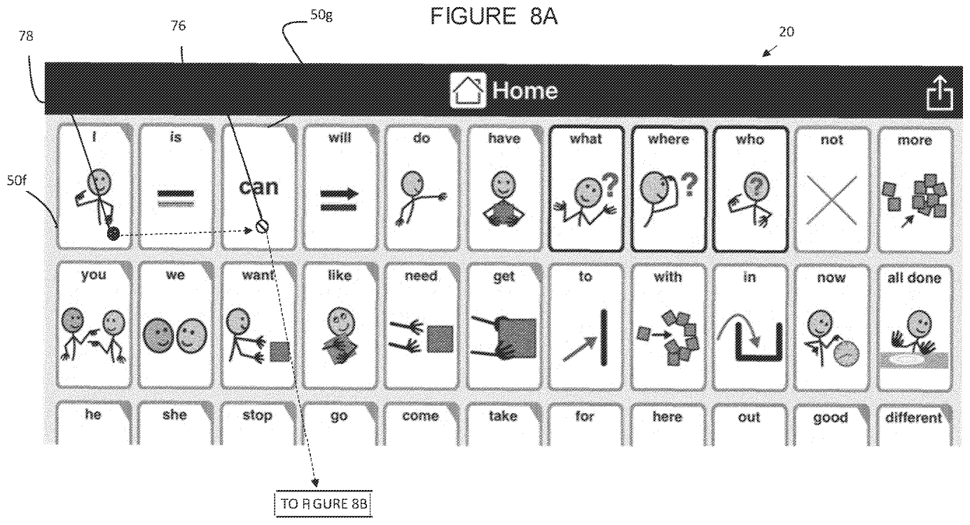

In some embodiments, the position in the keyboard affordance arrangement is determined based on a relative position of the previously selected affordance and/or the cursor. In some embodiments, such as in the example illustrated in FIGS. 7A to 7J, the affordances are arranged so that the most central affordance in the keyboard affordance arrangement is predicted to be the most likely text character.

FIGS. 7A to 7J show an example embodiment of a BIEUI 20 displayed on an electronic device 14 for selecting affordances to input graphical elements such as a text character into a text input field or box 72. In FIG. 7A a user has guided a cursor 76a to an affordance for inputting “h” into a text box 72 in a circular keyboard affordance arrangement SOc. Also shown in the BIEUI 20 shown in FIGS. 7A to 7J, by way of example, are a space button affordance SOd and one or more other examples of affordances which may form part of the keyboard affordance arrangement in some embodiments. In some embodiments, other, less likely, text characters are presented for selection using affordances arranged around the most likely central affordance of the keyboard affordance arrangement. In some embodiments, instead or in addition, the distance of a predicted next affordance from the current cursor location is dependent on the likelihood of the text character associated with that affordance following the previously selected character.

As an example, in some embodiments, as shown in FIGS. 7A to 7J, the way the next character is predicted is based on character pairs, so by inputting a text character, the probability of the next letter can be determined. In some embodiments, in addition, it is possible to also take into account a longer letter history, for example, a previously entered word or words, and in some embodiments the context of the device and/or previous text input and/or other information may be taken into account. FIG. 7B shows the updated keyboard affordance arrangement 50c following input of the letter h into text box 72 by selection of the affordance labelled “h” in the keyboard arrangement shown in FIG. 7A. To select the letter “e”, the user now moves the cursor only to the central affordance in the keyboard shown in FIG. 7B, whereas previously that affordance was on the far side of the keyboard shown in FIG. 7A. The distance a user must navigate the cursor 78a is accordingly now reduced to just the position shown in FIG. 7C. Selection of the “e” in the keyboard of FIG. 7C causes text input of the letter “e” to the text field box 72 and the update of the keyboard affordance arrangement to the arrangement shown in FIG. 7D. In FIG. 7D the user navigates the cursor to the position of the “I”, which is now in a different position in the first tier of affordances of the keyboard from its position in the keyboard shown in FIG. 7C, but the same distance for a user to navigate to from their current position. Selection of the “I” in FIG. 7D, results in the text entry of the first “I” into text input field 72. The keyboard may not always update responsive to selection of an affordance, as shown in FIGS. 7E to 91, when the second “I” is input into the text input field. Finally, the user selects “o” in FIG. 7J, to spell “hello”.

In some embodiments, such that shown in FIGS. 7A to 7J, the affordances are arranged in a keyboard comprising at least one circular tier of affordances arranged around a central affordance, wherein the central affordance presents the most likely next text character for selection and the adjacent circular tier of the at least one circular tier presents a plurality of next most likely text characters. Each circular tier may be associated with a range of dynamically determined likelihoods of a next text character. In some embodiments, the range of dynamically determined likelihoods is dynamically determined to always present a fixed number of affordances in at least the first tier of affordances around the central affordance of the keyboard affordance arrangement.

In some embodiments, as shown in FIGS. 7A to 7J, a number of affordances in another, second, tier of affordances presented adjacent the first tier of affordances varies according to a number of text characters predicted to be the next input text character exceeding a threshold.

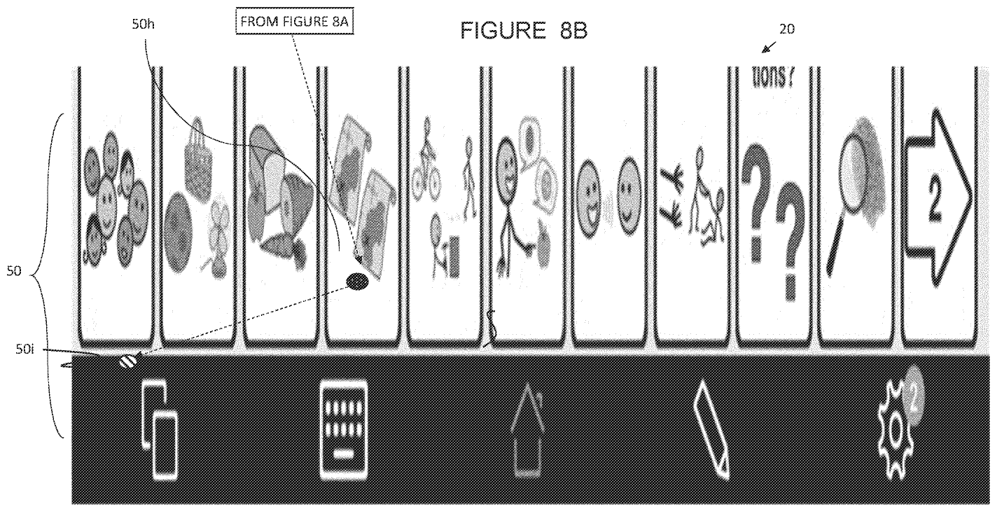

FIGS. 8A and 8B illustrate schematically another example of a keyboard type of user interface known in the art. FIGS. 8A and 8B show an example of a user interface which is configurable to accept breath user input. The user interface provides a fixed array of elements however, which means a user may need to traverse a long distance using their gaze to select affordances which are far apart on the display. For example, the phrase “I can help people” requires a user to navigate the cursor 76, 78 after selecting the “I” affordance 50f to move the cursor to over the affordance “can” 50g, in FIG. 8A and then to move the cursor to over the “help” affordance SOh and then to move the cursor “people” affordance 50i which are shown in FIG. 8B.

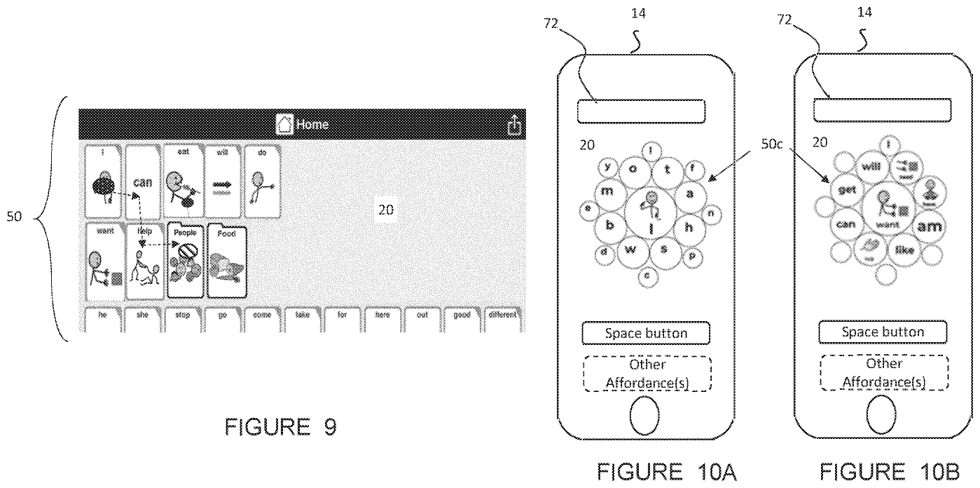

FIG. 9 illustrates schematically how the keyboard of FIGS. 8A to 8C may be reconfigured according to some embodiments of the disclosed technology. FIG. 9 shows how the keyboard of FIGS. 8A to 8C may be reconfigured to provide a text input user interface according to the disclosed technology in which the distance between selectable affordances 50f, 50g, 50h, 50i varies dynamically depending on the previously selected affordance or affordances.

FIGS. 10A and 10B illustrate schematically two other examples where a device is configured to provide a keyboard affordance arrangement BIEUI for breath input according to some embodiments of the disclosed technology. As shown in FIGS. 10A and 10B show two other examples of a breath UI for text input in which the selectable keyboard affordances included in addition to text characters a graphical indicator in the “I” affordance of FIG. 10A and affordances which comprise words in the affordance of FIG. 10B. The words in FIG. 10B may be selected for inclusion in a dynamic manner based at least in part on which previously displayed affordance was selected by the user's breath input, for example, based on selected letter pairs.

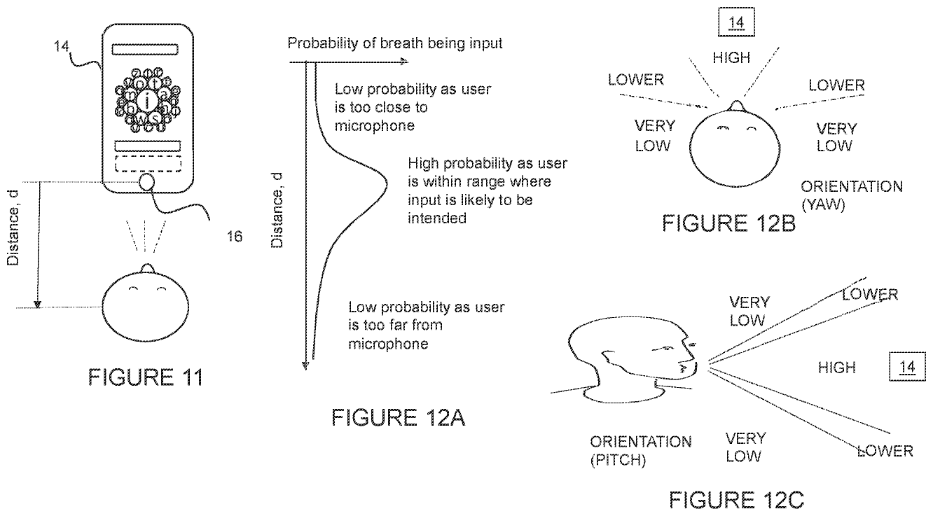

FIGS. 11 and 12A illustrate schematically how a probability of a user's breath being determined to be breath input to a breath enabled user interface may be dependent on a distance, d, of a user's mouth from a breath input sensor according to the some of the disclosed embodiments. As shown in FIG. 12A the probability of being breath input is not linear according to how close a head of a user is determined to be from the microphone 16 of the device 14. If a user is too close, there is a lower likelihood, if the user is too far away there is also a lower likelihood, however, when the user is not too far or too close, their position is optimal for their breath to be taken as breath input. Finding the optimal position for their breath to be taken as breath input however, is not easy for a user. FIG. 12B shows how the probability of audio input being breath input may depend on the relative side to side or yaw orientation of a user's face to the electronic device 14 and FIG. 12C shows how the probability may vary depending on the pitch of a user's face relative to the electronic device 14.

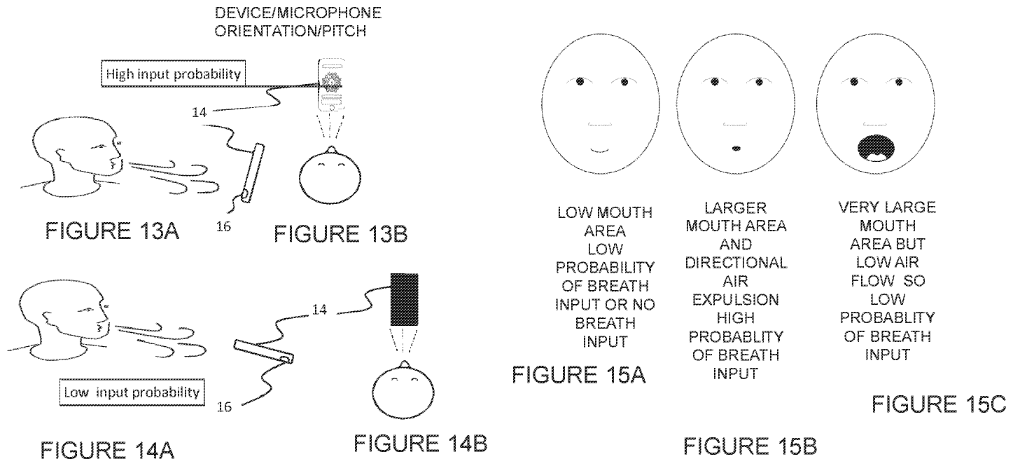

Other factors which may affect whether a user's breath forms acceptable breath input to a BIEUI include the relative orientation of the users face, for example, see FIGS. 13A and 13B for example which illustrate schematically an example of how the probability of a user's breath being input may be dependent on the orientation of an electronic device and the position of a breath input sensor relative to a user's mouth according to the some of the disclosed embodiments. In FIG. 13A a user is breathing towards a device 14 where the microphone 16 is tilted towards the user's mouth, indicating a higher degree of the input being intentional breath input than the low input probability that results from the example shown in FIGS. 14A and 14B. FIGS. 14A and 14B illustrate schematically another example of how the probability of a user's breath being input may be dependent on the orientation of an electronic device and the position of a breath input sensor relative to a user's mouth according to the some of the disclosed embodiments, where the microphone (and screen showing the BIEUI) are tilted away from a user's head, resulting a low probability that any audio input 26 will be intentional breath input to the BIEUI.

FIGS. 15A to 15C illustrate schematically an example of how the probability of a user's breath input may be dependent on the user's mouth area according to the some of the disclosed embodiments. As shown, a low or very large mouth area correspond to a low intentional breath input probability whereas an optimum mouth area may be determined in addition with facial features indicating “puffed cheeks” or the like, which would be associated with a high probability of any detected audio input 26 comprising intentional breath input.

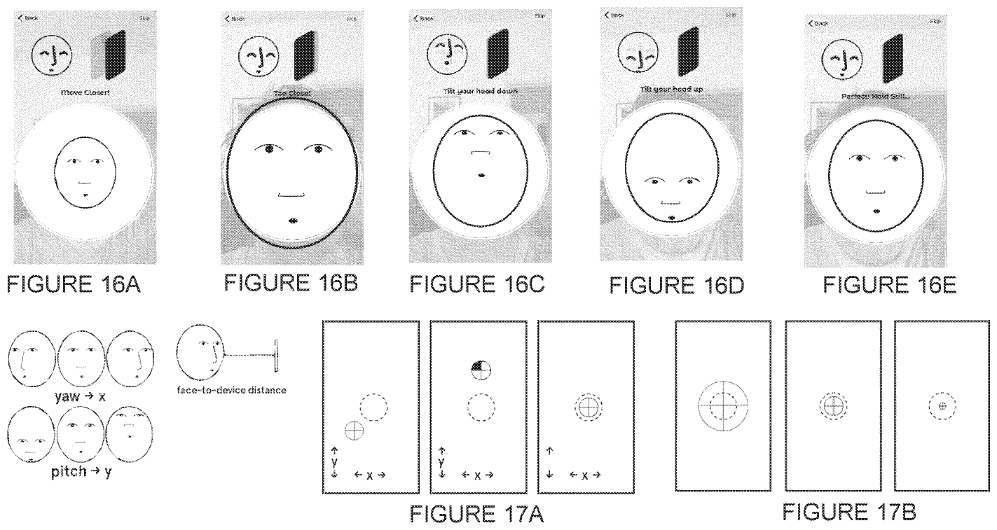

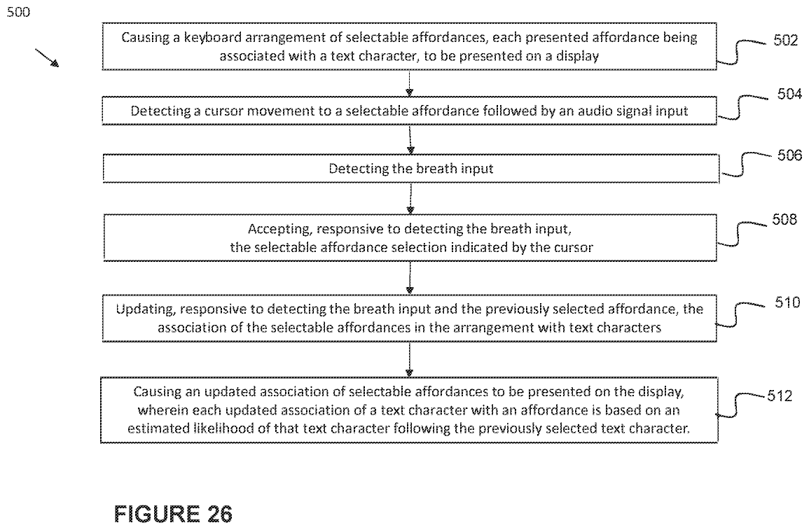

FIGS. 16A to 16 E show an example of a BIEUI which provides training to a user on how to position their head by a device 14 performing a method according to an embodiment of the second aspect disclosed herein and described in more detail in FIG. 26. In FIG. 16A, the device is too far away, in FIG. 16B, the device is too close, in FIG. 16C, the head is pitched up, in FIG. 16D the head is pitched down, in FIG. 16E the user has correctly positioned their head facing the device at the correct distanced from the device to maximise the likelihood of any audio signal 26 a microphone 16 generates as a result of the user providing breath input to the device 14 being determined to be intentional breath input to a BIEUI 20 of the device 14. In FIGS. 16A to 16E, the big circle is camera input, the head top left is the pitch indicator, and the device moves left to right according to distance of the device 14 to the face of the user. The face representation could also show yaw and roll, and an optimum mouth area in some embodiments. In some embodiments, the device could show also device orientation relative to gravity or user In some embodiments, an application running on the electronic device 14 causes the electronic device to perform a method according to the second aspect in which correct positioning by a user automatically triggers an update of the UI to the next screen, in other words, in some embodiments, once a user's head is in a correct position for their breath input to be optimally detected as intentional breath input, the training session screen transitions and presents a sequence of screens where visual/audio indicators are provided to guide a user to provide breath input which is optimally likely to be considered intentional input of a particular type based on the audio signal detected from the user's breath.

FIG. 17A illustrates another way for an example BIEUI to indicate a user's head position when performing a method according to the second aspect. From left to right, the BIEUI indicates if the user's head is too close, in an optimal position for intentional breath input to be detected, and when the device 14 is too far away from the user's head. FIG. 17B illustrates schematically from left to right a way of indicating to a user when their head is pitched down, pitched up or in an optimal position for breath to generate an audio signal 26 which will be determined to be intentional breath input.

In some embodiments, an alternative indicator translates the pitch and yaw of the face to x and y coordinates. This moves a cursor (the cross as shown in the BIEUI shown in FIG. 17B); the cross should be lined up in the centre of the screen with the dotted circle, aligning these circles mean the head is at correct orientation. The circle scales with distance, larger with closer, smaller when further away—the cross is larger than the indicator circle when too close

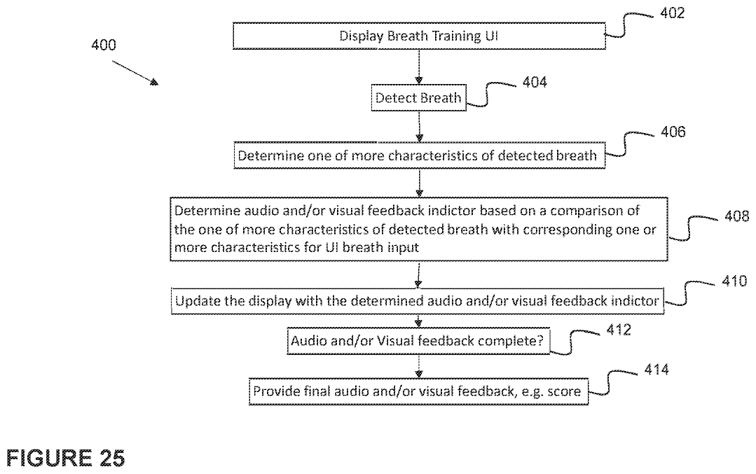

Some embodiments of the disclosed technology relate to a computer-implemented method for training a user to provide breath input acceptable by a breath input enabled user interface, BIEUI, the method comprising on an electronic device. The method may comprise the method 400 shown in FIG. 25 which comprises the electronic device 14 displaying 402 a breath input training BIEUI 18, detecting 404 audio input 26, determining 406 one or more characteristics of the detected audio input, determining 408 a conformance of one or more characteristics of the detected audio input with corresponding one or more characteristics of a predetermined type of intentional breath input to the breath input training BIEUI 18, and causing 410 at least one visual indicator of the conformance to be presented in the breath input training BIEUI. The feedback may be provided in a loop until the user has provided an acceptable breath input by positioning their head and face orientation relative to the device, the microphone of the device. In some embodiments the position may be determined relative to an external display showing the BIEUI if this is not provided on the device 14 having the microphone detecting the audio signal (for example, if the device 14 is used as a microphone and the BIEUI is projected on to an external display). Once the audio and or visual feedback training exercise is complete 410, an exercise or end of session score may be provided 414 visually or audibly to the user via the device 14 in some embodiments.

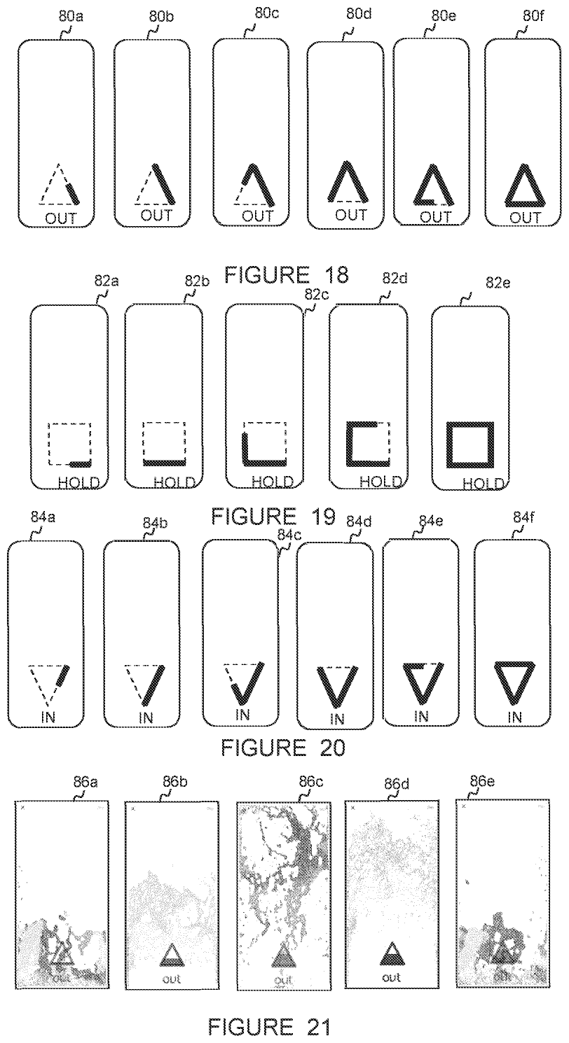

FIG. 18 illustrates schematically an example screenshot sequence 80a to 80f in a breath input enabled user interface configured to train a user to provide a breath input to a breath input enabled user interface input by exhaling using visual indicators provided on a BIEUI 18 on a display 22, for example, by a device 14 performing a method of providing a BIEUI for training a user to provide more acceptable intentional breath input in some embodiments of the invention. FIG. 25 shows an example of such a method as method 400. In FIG. 18, the indicator arrow shows a timing to breathe out (also fills up with volume and moves on to next stage once have met a specified volume).

FIG. 19 illustrates schematically an example screenshot sequence 82a to 82e in a breath input enabled user interface configured to train a user to provide a breath input to a breath input enabled user interface input by holding their breath in or out using visual indicators provided on a BIEUI 18 on a display 22, for example, by a device 14 performing a method of providing a BIEUI for training a user to provide more acceptable intentional breath input in some embodiments of the invention.

FIG. 20 illustrates schematically an example screenshot sequence 84a to 84f in a breath input enabled user interface configured to train a user to provide a breath input to a breath input enabled user interface input by holding their breath in or out using visual indicators provided on a BIEUI 18 on a display 22, for example, by a device 14 performing a method of providing a BIEUI for training a user to provide more acceptable intentional breath input in some embodiments of the invention.

FIGS. 21 to 24 each illustrate schematically other examples of screenshots sequence in a breath input enabled user interface configured to train a user to provide a breath input to a breath input enabled user interface input by exhaling which provide examples of foreground and background visual indicators of a BIEUI 18 on a display 22, for example, by a device 14 performing a method of providing a BIEUI for training a user to provide more acceptable intentional breath input in some embodiments of the invention.

An example of a foreground graphic visual indicator is an animation which shows a shape such as a triangle which fills up with successful breath input over time. For example, the shape or triangle may fill up with breath exhalation input being detected to be a certain magnitude, or dependent on the determined flow rate of breath exhalation. In other words, in some embodiments of the method according to the second aspect, the electronic device is configured to generate screenshots which show a foreground visual indicator filling relating to the exhaled breath volume, also referred to as expired breath volume.

An example of a background graphic visual indicator includes an adjustments to a background colour or gradients, a change of position, velocity, or scale, or opacity, or rotation, or iteration step for cellular automata or other moving objects in a dynamic background image, changes to simulation parameters such as gravity, viscosity, virtual wind force for a fluid, soft body and rigid body simulations, attraction/repulsion animations, virtual gravity, 3d virtual camera position, camera rotation, displacement, texture mapping, expansion contraction, distortion of shape of a background image.

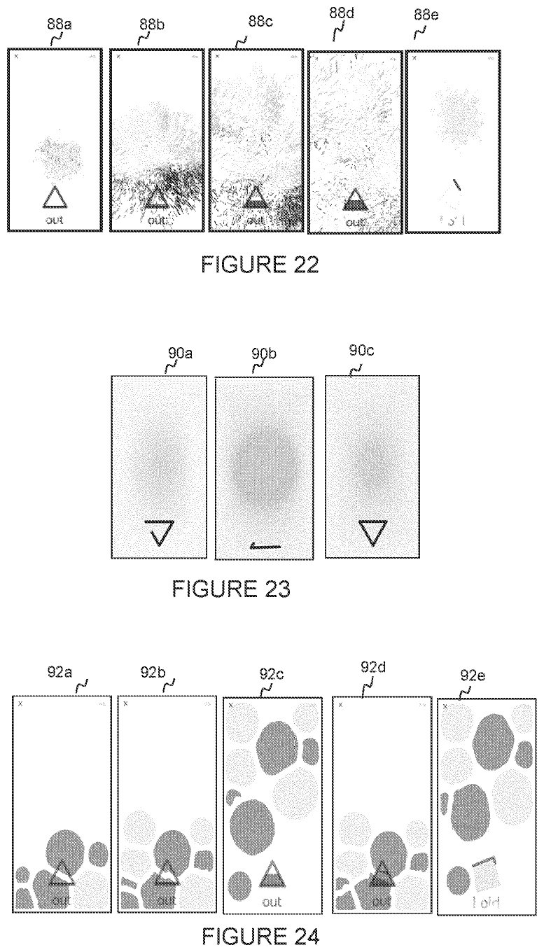

FIG. 21 shows a sequence of screenshots 86a to 86e, FIG. 22 a sequence of screenshots 88a to 88f, and FIG. 23 a sequence of screenshots 90a to 90c. FIGS. 21-23 show example visual indicators of breath input. In the leftmost image in all is prior to breath input, moving right is progressing in time, the second and third frame in each sequence shows the response to breath input.

FIG. 22 shows a ‘boid’ flocking simulation, with dispersion of the particles linked to breath input. FIG. 88a is prior to breath input, FIGS. 88b-88d is after breath input showing dispersion of the boid particles, 88e is after breath input has finished and shows reforming of the boid particles

FIG. 23 shows a fluid simulation with the gravity, turbulence, colour of the fluid particles linked to breath input. FIG. 23 shows screenshots 90a to 90c which illustrate an example of how technical information relating to how a user's breath is being detected may be graphically indicated using visual feedback elements such a foreground triangle which is traced out as a user inhales and where a background visual effect comprises a soft gradient, a different contrast area or different colour circle expanding and becoming more vivid with the breath input. In some embodiments, a rippling out of colour outwards may provide a visual cue regarding how characteristics of a user's breath is being detected by the electronic device and, in some embodiments, checked for conformity with a target type of breath input. In FIG. 23, the downwards triangles in screenshots 90a and 90c indicate inhalation, and the upwards triangle in screenshot 90b shows exhalation. The dominance in the background of the diffuse region in screen 90b further indicates the response of the breath detector module 52 and breath controller 128 to the audio input 26 provided by the microphone 16 which the user's breathing has generated.

In FIG. 24, screenshot 92b shows the user addition of a soft body via touch input to screenshot 92a which can be interacted with. Screenshot 92c shows breath input, with expansion and moving of the soft body blobs. Screenshot 92d shows finished breath input, with screenshot 92e showing a subsequent breath input.

In FIGS. 21 to 24, the background graphics also response to the user input indicated, in for example, the foreground by providing a fill within a shape, or by the arrow moving up with breath volume (which is a sum of the amplitude, a measure of velocity/flow, of breath over time) in some embodiments. In some embodiments, instead or in addition, in the background of the BIEUI, the breath input disperses the boids displayed in the BIEUI on display 22, adds new forces to the fluid simulation e.g. gravity, a vortex, turbulence, noise, directional force; expands and blows around the soft body simulations.

In some embodiments, in addition to visual indicators, audio indicators may be provided: generation of MIDI sequence, arpeggiation, pitch, chord changes, audio volume, low or high pass filtering, starting note, scale type, length of MIDI sequence, oscillator parameters/synthesiser parameters-attack, sustain, decay, release and noise generation. Other background graphic visual indicators may include, in addition to those as mentioned above, one or more of the following: adjustments to colour/gradients, position, velocity, or scale, or opacity, or rotation, iteration step (for cellular automata), simulation parameters e.g. gravity/viscosity/virtual wind force (for fluid, soft body, rigid body simulations), virtual gravity; 3d virtual camera position, camera rotation, displacement, texture mapping, expansion contraction, distortion of shape.

It is also possible to provide similar graphics to those described as foreground graphics above to background graphics and vice versa in some embodiments.

In some embodiments, method 400 comprises instead or in addition providing visual guidance on in the form of a generative animated graphic, or UI element for breath characteristics, a user's head position and/or orientation relative to the electronic device and the electronic device's position and/orientation relative to the user's mouth. A series of visual guidance sessions to address the above may be provided in some embodiments, with the electronic device automatically transitioning from one screen to the next when the user has successfully completed the guidance activity of each guidance session.

In some embodiments of the method of the second aspect, the user interfaces used to guide the user to position their head and/or the device may not be BIEUIs in some embodiments of training sessions for these activities and the user interface of the device may adopt a BIEIUI state only when breath input is being guided. In some embodiments of the method 400, the determining the conformance comprises performing a method of breath input recognition according to any of the disclosed embodiments and if the audio input 26 fails to conform with the one or more characteristics of a predetermined type of intentional breath input to the BIEUI, the audio data is processed to prevent the audio data 26 form the microphone being provided as unintentional or otherwise unacceptable breath input to the BIEUI.

In some embodiments, the determining the conformance comprises performing a method of breath input recognition according to any one of the disclosed embodiments results in a determination that audio input 26 conforms with the one or more characteristics of the predetermined type of intentional breath input to the BIEUI, in which case the audio input 26 forms intentional breath input which, if acceptable may be provided as breath input to the BIEUI. In some embodiments, acceptable breath input is any intentional breath input, however, as mentioned above, in some embodiments, additional steps such as authentication and/or verification the type of breath input is of an expected type is required.

In some embodiments, the at least one visual indicator of the conformance comprises causing presentation of a video or animated graphics or similar UI element comprising one or a combination of one or more of the following, either sequentially or as a combination: tracing a shape outline on the display, wherein the direction and speed at which the shape outline is traced is determined in real-time based on a score indicative of the conformance, for example, as shown schematically in the sequences of screenshots shown in each of FIGS. 18, 19, and 20, filling a shape outline presenting on the display, for example as shown in the sequences of screen shots in each of FIGS. 21 to 24, wherein the speed at which the shape outline is filled is determined in real-time based on a score indicative of the conformance; and modifying at least one dynamic background graphical element, wherein one or both of the direction and speed of the dynamic background graphical element is based on a score indicative of the conformance, for example, as shown in the sequence of screen shots in each of FIGS. 21 to 24.

In some embodiments, where a final session or training sequence score is provided, this may be dependent on at least the detected magnitude of the audio input which forms intentional breath input. In some embodiments, the score may be modified and based only on intentional breath user input of a type which the BIEUI can accept.

FIG. 26 illustrates schematically an example of a method 500 performed by an electronic device to provide a breath input enabled user interface for selecting text according to some of the disclosed embodiments described above. In FIG. 26, the method 500 comprises causing 502 a keyboard arrangement of selectable affordances, each presented affordance being associated with a text character, to be presented on a display, detecting 504 movement of a cursor or similar visual indicator onto, or on a path towards, a selectable affordance followed by an audio signal input. If the audio signal input is detected to be an intentional and acceptable breath input 506, the method comprising accepting 508, responsive to detecting the breath input, the selectable affordance selection indicated by the cursor, and, updating 510, responsive to detecting the breath input and the previously selected affordance, the association of the selectable affordances in the arrangement with text characters. In the embodiment of method 500 illustrated in FIG. 26, the method then causes an updated association of selectable affordances to be presented in the BIEUI 20 on the display 22. Each updated association of a text character with an affordance 50 is based on an estimated likelihood of that text character following the previously selected text character which may be determined using any suitable text character input prediction technique.

By using a combination of microphone input and facial-tracking breath signal inputs can be used to interact with a BIEUI on an electronic device 14 such as a smartphone to provide breath input equivalents of UI functionality which might otherwise be provided by one or more button presses or touch or gesture inputs such as, for example, navigation/scrolling and device activation. This enables hands-free interaction or activation for non-disabled users and an added assistive input for disabled or less able users. Real-time user feedback on breathing input, for the purposes of a game, meditation app or breathing exerciser application, may also be provide and an expressive new input device with multi-parameter input for an audio/visual instrument can be provided in some embodiments in the form of an apparatus configured to perform one or more or all of the disclosed methods 200, 300, 400 or 500.

In some embodiments, the electronic device 14 comprises an apparatus such as smartphone configured with hardware which can be modified using a to recognize when the user breathes. With these data it can create responsive visuals and audio in real-time, as well tracking and monitoring every breath. This unique approach forms the basis for a novel platform, which can be used as a breathing trainer, a ‘wellness’ or meditation app, or a more creative interactive experience. The application is intended to be accessible and engaging, but also to improve both physical and mental health, through regular breathing exercise. The electronic device in some embodiments comprises an apparatus comprising memory, a processor, and computer program code stored in the memory, wherein the computer program code, when loaded from memory and executed by the one or more processors causes the apparatus to perform a method according to any one of the disclosed method aspects.

The apparatus may also use a computer program comprising a set of machine executable instructions, which, when loaded and executed on the apparatus causes the apparatus to perform a method according to any one or more or all of the disclosed method aspects.

The audio module 32 and breath detection module 34 disclosed herein provide ways of determining a probability threshold above which an audio signal which is consistent with predefined parameters from the microphone is interpreted as a ‘breath signal’ from the user. A detected face raises the probability that a signal from the microphone/pressure sensor/breath sensor is from a user breath. Additionally, other parameters could be added to raise the accuracy of detecting true positive and reducing the chance of false positives, where detected audio signals are incorrectly detected as breath input. Examples of other parameters which may be taken into account in or more or all of the above disclosed embodiments to recognize or detect breath input include:
i) Camera/face tracking may be used in some embodiments as described above to provide orientation information of the user's face/head (yaw/pitch/roll). If the user's head/face is orientated toward the device 14 it is assumed the device has their attention which raises the probability that any audio signal which resembles breath input is intentional breath input.
ii) Depth-within a certain threshold distance, likely<1 m;
iii) Mouth area-facial tracking can calculate mouth area and a mouth area below a certain threshold indicates a mouth is closed and unlikely to be provided an input breath signal;
iv) Facial expression-breathing out through the mouth is associated with more general changes in facial expression ‘O’ shaped mouth-facial muscles activating obicularis oris—and detecting such changes may increase the probability that detected audio input 26 from the microphone is intentional breath.
v) A Deep learning model data set may be used to train a ML model. The data set may comprise data representing users breathing/not breathing/and other stimuli that might result in a false positive may; These data could also be obtained from single users to customize the breath input detection. Certain users, for example, users with respiratory disease/neurological disorders may have very weak breath and the thresholds for audio signals being breath input may be adjusted accordingly.
vi) Authentication may also be required or used in conjunction with providing a customized threshold for breath detection for users of devices which may detect input from multiple users. By combining facial recognition/authentication a device 14 may be activated only by an authenticated specified user in some embodiments (i.e. all other breath inputs even if clearly intentional from other people or the specified user if not authenticated properly would be ignored).
vii) The combination of microphone and camera input not only greatly improves the detection of correctly detecting breath input, but also enables additional BIEUI functionality to be provided by a device 14. For example, the device 14 may to one or more of the following in some embodiments:
viii) Combine facial tracking to obtain an orientation of user's face/head where he user's head orientation can be converted to a 2D co-ordinate system to interact with UI elements positioned on a display (video) to guide a cursor or similar indicator;
ix) Use eye-tracking/gaze-tracking—to interpret where the user is looking, similarly to interact with a UI element on a display;
x) Use concurrent or simultaneous facial/head orientation tracking with prolonged inhaled or exhaled breath input to scroll/pan/read, in a manner akin to tap and drag hold;
xi) Use simultaneous head movement with breath for gesture recognition tap, pinch, swipe (related to head yaw), rotation (related to head roll);
xii) Provide visual indicators to a user to hold the device 14 correctly to accurately track user breathing for use in a meditation/breathing application/game or to create a constant orientation/distance in which to track breathing input for more objective results;
xiii) Enable the overlay of AR elements on the user's face to encourage breathing responding to real-time facial tracking;
xiv) The relative position/spatial relationship of the device and the user can be used as a multivariate model for breath detection, in which the orientation/distance of the device from the user can be compensated for in the detected magnitude of the breath signal. In other words, a breath signal with the user at a reasonable distance with their face/mouth orientated towards the device would be associated with a larger breath signal. In this manner, an estimation with model of air around the user/in larynx airway spaces may be obtained using additional sensor data to create a potentially more accurate, spatial map of breath input in real-time. Additionally, as mentioned above, in some embodiments a mouth area is calculated and this may be used to give flow rate for a user.

In some embodiments, only amplitude tracking based on air pressure on the microphone is used where an increase in the pressure, dB, is determined to be a breath signal when over a threshold. Alternatively, or instead, in some embodiments mentioned above, the audio could also be processed to be more specific for breath input. For example, a set of predefined parameters for detecting breath from the microphone may depend on a signal, i.e. raise in pressure at microphone sensor which relates to a raise in dB (above background noise). This signal would be over a given threshold (the threshold can be set according to ambient noise conditions, i.e. it is higher in noisier environments). Breathing/air turbulence may cause a low frequency peak at<500 Hz-microphone input can be band-pass filtered according to this threshold—or signal detected in this band would be considered more likely to constitute a breath signal. The magnitude of the breath signal/amplitude can be used to quantify the breathing input. In some embodiments this may result in additional fidelity in user breath input as e. breath magnitude may be graded into categories—soft/light, medium, heavy which may result in additional or alternative forms of user input. Alternatively, a machine learning model may be used or other form of AI model to classify audio data into breathing detected/not/exclude invalid inputs/quantify according to flow rate etc.

User input may also form a personalized data set, for instance in users with weak breath the threshold for breathing may be lower (or the microphone sensor more sensitive) in some embodiments.

In some embodiments, the camera tracking data provides the ability to track a user's face and the distance of the face from the device 14 (or camera 18) may be used to adjust the sensitivity of the microphone 16 to user breath input (or lower threshold for input).

The microphone 16 may detect breath as an increase in audio signal amplitude over a threshold in some embodiments. The simultaneous breath signal may be detected by simply filtered audio input at a frequency of 500 Hz and looking for a spike/signal in the filtered range; or, additionally, in some embodiments if the input is quantifiable, different magnitudes of breath input may be associated with a firmer/stronger breath input, akin to a pressure sensitive touch display UI responsive to a soft or hard press.

One example of a BIEUI which is configured to use one or more of the methods disclosed herein comprises a BIEUI for an application which uses breath input to drive visuals and audio with responsive breathing and meditation exercises. As another example, a BIEUI application may be used in assistive devices—for less ably bodies enabling them to perform various tasks such a steering an autonomous vehicle/wheelchair where the direction is determined based on their head movement or eye tracking but with breath input providing the confirmation (go signal).

Another example of other use cases of BIEUI applications which may run on a device 14 configured to perform at least the method of breath input recognition according to at least one of the disclosed embodiments accordingly includes in car navigation.

Functionality which a BIEUI may provide include unlocking a phone/device, answering a phone call, playing an instrument, turning a page of an e-book, snoozing an alarm clock, playing/pausing audio/video, using breath input such as a blow to turn pages and breath input comprising prolonged breath and head movement to drag; e.g. whilst playing piano/guitar.

BIEUI navigation may be provided by device 14 if the BIEUI is configured to accept a prolonged breath with head movement/eye movement to scroll through content in some embodiments. Breath input may be accepted by BIEUIs in a similar manner to conventional UI gesture based on a touch screen device by replacing swiping, panning, pinching, rotating triggering touch inputs with input based on the head position tracking parameters and different types of breath input.

The device 14 may comprise an instrument in some embodiments where breath input and face/eye tracking along with orientated of head/eye may be used to control pitch/volume/modulation. The device 14 may comprise a Kiosk/ticket/bank terminal in some embodiments.

FIG. 27A illustrates schematically an example electronic device on which the disclosed method embodiments are performed. Example embodiments of an electronic device on which a BIEUI may be provided according to the disclosed embodiments include wireless communications devices, for example, a smart phone, a mobile phone, a cell phone, a voice over IP, VoIP, phone, a wireless local loop phone, a desktop computer, a personal digital assistant, PDA, a wireless cameras, a gaming console or device, a music storage device, a playback appliance, a wearable terminal device, a wireless endpoint, a mobile station, a tablet, a laptop, a laptop-embedded equipment, LEE, a laptop-mounted equipment, LME, a smart device, a wireless customer-premise equipment, CPE, a vehicle-mounted wireless terminal device, etc. However, the BIEUI may also be provided on a kiosk or terminal or other computer provided with a camera and microphone and display for the BIEUI which need not be wireless. There is no need for the BIEUI to be provided on a communications enabled device providing it is configured with the appropriate applications to execute computer code to implement one or more of the disclosed methods. For example, home or personal appliances (e.g. refrigerators, televisions, heating controllers, etc.), and personal wearables (e.g., watches, fitness trackers, etc.) may be provided with a BIEUI according to a disclosed embodiment.

FIG. 27A illustrates schematically in the form of a block diagram the functionality of an electronic device 14 with a touch-sensitive display such as smart phone which may be configured to perform some embodiments of the disclosed methods and which may be configured to provide a BIEUI according to one or more of the disclosed embodiments. As illustrated, the electronic device 14 includes a memory 94, processor(s), for example, CPUs which may be general or dedicated, for example, a graphics processing unit, GPU, 68. Also shown in FIG. 27A is a memory controller 96, and a data interface 98 for receiving and sending data to other components of the electronic device. If the device is wireless communications enabled, then RF circuitry 100 may be provided for data to be send and/or received via one or more antennas. Audio circuitry 106 provides audio data to speaker 108 and receives raw microphone data input via microphone 16. A control subsystem 116 comprises a display controller 118 for an internal, or in some embodiments external, display 22, for example, a touch screen display, an optical sensor controller for any optical sensors 18, 122, for example, for a camera 18 and/or for any depth imaging sensors 122. Other input device controllers may also be provided in some embodiments for other sensor and input devices. For example, temperature sensors and controllers could be provided. Also shown in FIG. 27 is a breath input controller 128 for a breath input sensor 130, for example, a heat map sensor could be used to detect breath spatially. As illustrated this is also controlled by the breath input controller 128 which uses microphone 16 to detect breath input. It will be appreciated, however, that breath sensor 130 may be the microphone 16 in some embodiments.

It will be understood that in other embodiments electronic device 14 as illustrated in FIG. 27A may have more or fewer components than shown, may combine two or more components, or a may have a different configuration or arrangement of the components. The various components shown in FIG. 27A may be implemented in hardware, software or a combination of both hardware and software, including one or more signal processing and/or application specific integrated circuits.

Memory 94 may include high-speed random access memory and may also include non-volatile memory, such as one or more magnetic disk storage devices, flash memory devices, or other non-volatile solid-state memory devices. Access to memory 94 by other components of the electronic device 14, such as the processor(s) 68 and the interface 98 may be controlled by controller 96.

The data interface 98 couples the input and output peripherals of the device to the processors 68 and memory 94. The one or more processors 68 run or execute various software programs and/or sets of instructions stored in memory 94 to perform various functions for the electronic device 14 and to process data.

In some embodiments, the interface 98, one or more or all of the processor(s) 68, and the controller 96 may be implemented on a single chip or on separate chips.

In embodiments where the electronic device is configured to perform wireless voice and/or data communications, the RF, radio frequency, circuitry 100 receives and sends RF signals to enable communication over communications networks with one or more communications enabled devices. By way of example only, RF circuitry 108 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF circuitry 100 enables electronic device 14 to communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TOMA), Bluetooth, Wireless Fidelity (Wi-Fi) (e.g., IEEE 802.IIa, IEEE 802.IIb, IEEE 802.IIg and/or IEEE 802.IIn), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol, including communication protocols not yet developed as of the filing date of this document.

The audio circuitry 106, speaker(s) 0108, and microphone 16 provide an audio interface between a user and the electronic device 14. The audio circuitry 106 receives audio data from the interface 98 for speaker 108 and receives electrical signals converted by the microphone 18 from sound waves. The circuitry 110 converts the electrical signal to audio data and transmits the audio data to the data interface 98 for processing and forwarding via the control subsystem to breath input controller 128 in some embodiments. Audio data may be retrieved from and/or transmitted to memory 94 in some embodiments by the data interface 88. In some embodiments, the audio circuitry 106 may include a headset jack for removable audio input/output such as input from an external microphone and/or earphones/headphones.

The control subsystem 116 couples input/output peripherals on the electronic device 14, such as the touch screen 112 and other input/control devices to data interface 88, including the breath input controller 128.

Display 22, which may in some example embodiments comprise a touch screen, provides an input/output interface between a user and the electronic device 14. The display controller 118 sends electrical signals from/to the display 22 and receives input via the use's interactions with any displayed UI elements, for example, from a user's touch and/or from a user's breath via the BIEUI. In some embodiments, a brain-machine interface may be provided in addition to or instead of a touch UI along with a BIEUI according to any of the disclosed embodiments. The display displays visual output which may include graphics, text, icons, video, and any combination thereof (collectively termed “graphics”) in the form of one or more user interfaces which may include one or more affordances. An affordance is a graphical element or object presented in a user interface which includes a feature or graphic that presents an explicit or implicit prompt or cue on what can be done with the graphical element or object in the user interface. An example of an affordance is an icon represented by a tick-mark to accept a displayed condition. Another example of an affordance is a loudspeaker symbol icon whose selection triggers or enables audio or music output. In some embodiments, some or all of the visual output may correspond to user-interface objects, further details of which are described below.

A touch screen embodiment of the display 22 may include a sensor or set of sensors that enable input from the user to be accepted based on the position of a cursor guided by breath and/or by sensing haptic and/or tactile contact. The display 22 and display controller 118 (along with any associated modules and/or sets of instructions in memory 94) are configured to detect input at a position on the display and convert the input into interaction with one or more user-interface objects (e.g., one or more soft keys, icons, web pages or images) presented on the display 22.

The display may use any suitable technology including but not limited to LCD (liquid crystal display) technology, or LPD (light emitting polymer display) technology. The display controller may be configured to a combination of one or more of the optical sensors 18, 122, along with the proximity sensor 112 and/or the accelerometer 114 in some embodiments to determine one or more of a user's head position, facial characteristics of the user's face, the orientation of a user's face relative to the display and/or camera and/or microphone and also, optionally, to track a user's gaze.

Suitable techniques to track a user's gaze are well known in the art, as are techniques to extract facial characteristics of a user's face and accordingly no further detail will be provided herein.

The electronic device may be powered from an alternating mains source or from a direct current, DC, source such as a battery.

The optical sensors 18, 122 may comprise a camera 18 and/or include one or more optical sensors 133. Examples of optical sensors 18, 122 include charge-coupled device (CCD) or complementary metal-oxide semiconductor (CMOS) phototransistors which converts received light into data representing an image. Camera 18 is a forwards facing camera which may be implemented as imaging module and may be configured to capture still images in addition to video. In some embodiments of the electronic device 14, a rear facing camera may also be provided.

The forward-facing camera optical sensor 18 is located on the same, front, side of the electronic device 14 as display 22 in some embodiments. Display 22 is also used as a viewfinder for detecting a user using video image acquisition in some embodiments.

FIG. 27B illustrates schematically a memory of the example electronic device of FIG. 27A holding computer-code which when executed causes the electronic device to implement one or more methods according to the disclosed embodiments.

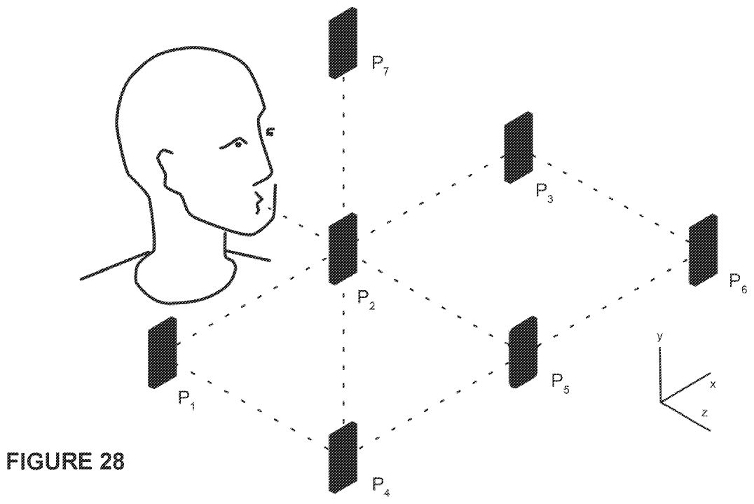

FIG. 28A shows schematically by way of example, memory 94 of the electronic device storing software components 132-142. As illustrated, memory 94 includes an operating system 132, a communication module (or set of coded instructions) 134, a text input module (or set of coded instructions) 136, a graphics module (or set of coded instructions) 138, a breath input recognition module 24, a breath input detector module 52 which may be a sub-module of the breath input recognition module 24, and one or more breath input applications (or set of instructions) 72, for example, one or more applications which use a BIEUI may be provided along with other applications 142.

The operating system 132 includes various software components and/or drivers for controlling and managing general system tasks (e.g., memory management, storage device control, power management, etc.) and facilitates communication between various hardware and software components. Communication module 134 facilitates communication with other devices over one or more external ports 102 and also includes various software components for handling data received by the RF circuitry 100. A text input module 136, which may be a component of graphics module 138, may be configured provides soft keyboards for entering text and/or displaying text in various applications needing text input. The graphics module 138 includes various known software components for rendering and displaying graphics on the display 22. As used herein, the term “graphics” includes any object that can be displayed to a user, including without limitation text, web pages, icons (such as user-interface objects including soft keys), digital images, videos, animations and the like.

In addition to one or more breath UI application modules 70, one or more other applications 142 may be provided including modules (or sets of coded instructions), or a subset or superset thereof for typical functionality found on so called smart devices or on the relevant type of applicant or device configured for breath user input using a BIEUI according to any of the disclosed embodiments, for example, if the electronic device is a smart phone, applications for voice and text communications, email, camera related functionality, and audio output may be provided. In conjunction with display 22, display controller 118, optical sensor(s) 18, 122 optical sensor controller 120, graphics module 138, a camera and/or image management module may be utilised by one or more or all of the disclosed embodiments of a method @ and/or one or more or all of the disclosed embodiments of a BIEUI to capture breath input.

Each of the above identified modules and applications correspond to a set of instructions for performing one or more functions described above. These modules (i.e., sets of instructions) need not be implemented as separate software programs, procedures or modules, and thus various subsets of these modules may be combined or otherwise rearranged in various embodiments. In some embodiments, memory 94 may store a subset of the modules and data structures identified above. Furthermore, memory 94 may store additional modules and data structures not described above.

In some embodiments, the electronic device 14 is configured to provide a predefined set of functions where breath user input is the primary input/control device for operation of the electronic device 14. In some embodiments, however, additional input via a touch or hover screen, via a brain-machine user interface, and/or via physical input/control devices (such as push buttons, dials, and the like) are also provided on the electronic device 14.

The predefined set of functions that may be performed exclusively by navigating between breath input enabled user interfaces in some embodiments. In some embodiments, the breath input user interface is used to navigate the electronic device 14 between menu items and/or screens which may correspond to an unlock screen, and depending on the operating mode of the electronic device 14 also to one or more of a main, home, or root menu of a BIEUI displayed on the electronic device 14.

Where the disclosed technology is described with reference to drawings in the form of block diagrams and/or flowcharts, it is understood that several entities in the drawings, e.g., blocks of the block diagrams, and also combinations of entities in the drawings, can be implemented by computer program instructions, which instructions can be stored in a computer-readable memory, and also loaded onto a computer or other programmable data processing apparatus. Such computer program instructions can be provided to a processor of a general purpose computer, a special purpose computer and/or other programmable data processing apparatus to produce a machine, such that the instructions, which execute via the processor of the computer and/or other programmable data processing apparatus, create means for implementing the functions/acts specified in the block diagrams and/or flowchart block or blocks.

In some implementations and according to some aspects of the disclosure, the functions or steps noted in the blocks can occur out of the order noted in the operational illustrations. For example, two blocks shown in succession can in fact be executed substantially concurrently or the blocks can sometimes be executed in the reverse order, depending upon the functionality/acts involved. Also, the functions or steps noted in the blocks can according to some aspects of the disclosure be executed continuously in a loop.

In the drawings and specification, there have been disclosed exemplary aspects of the disclosure. However, many variations and modifications can be made to these aspects without substantially departing from the principles of the present disclosure. Thus, the disclosure should be regarded as illustrative rather than restrictive, and not as being limited to the particular aspects discussed above. Accordingly, although specific terms are employed, they are used in a generic and descriptive sense only and not for purposes of limitation.

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that the example embodiments presented herein may be practiced in any combination with each other.

It should be noted that the word “comprising” does not necessarily exclude the presence of other elements, features, functions, or steps than those listed and the words “a” or “an” preceding an element do not exclude the presence of a plurality of such elements, features, functions, or steps. It should further be noted that any reference signs do not limit the scope of the claims, that the example embodiments may be implemented at least in part by means of both hardware and software, and that several “means”, “units” or “devices” may be represented by the same item of hardware.

The various example embodiments described herein are described in the general context of methods, and may refer to elements, functions, steps or processes, one or more or all of which may be implemented in one aspect by a computer program product, embodied in a computer-readable medium, including computer-executable instructions, such as program code, executed by computers in networked environments.

A computer-readable medium may include removable and non-removable storage devices including, but not limited to, Read Only Memory (ROM), Random Access Memory, RAM), which may be static RAM, SRAM, or dynamic RAM, DRAM. ROM may be programmable ROM, PROM, or EPROM, erasable programmable ROM, or electrically erasable programmable ROM, EEPROM. Suitable storage components for memory may be integrated as chips into a printed circuit board or other substrate connected with one or more processors or processing modules, or provided as removable components, for example, by flash memory (also known as USB sticks), compact discs (CDs), digital versatile discs (DVD), and any other suitable forms of memory. Unless not suitable for the application at hand, memory may also be distributed over a various forms of memory and storage components, and may be provided remotely on a server or servers, such as may be provided by a cloud-based storage solution. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

The memory used by any apparatus whatever its form of electronic device described herein accordingly comprise any suitable device readable and/or writeable medium, examples of which include, but are not limited to: any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry. Memory may store any suitable instructions, data or information, including a computer program, software, an application including one or more of logic, rules, code, tables, etc. and/or other instructions capable of being executed by processing circuitry and, utilized by the apparatus in whatever form of electronic device. Memory may be used to store any calculations made by processing circuitry and/or any data received via a user or communications or other type of data interface. In some embodiments, processing circuitry and memory are integrated. Memory may be also dispersed amongst one or more system or apparatus components. For example, memory may comprises a plurality of different memory modules, including modules located on other network nodes in some embodiments.

In some embodiments, the breath input enabled user interfaces, BIEUIs, may be provided as spatial interfaces in two or three dimensions. For example, a three-dimensional keyboard affordance arrangement may be provided in the form of a two dimensional projection in some embodiments, however, if a display supports a three dimensional BIEUI, for example, if the display supports augmented or virtual reality applications then the BIEUI may comprise a three-dimensional user interface. Examples of displays which support AR or VR BIEUIs include headsets and/or hard or soft holographic displays.

FIG. 28 illustrates schematically how a spatial map of breath input magnitude may be created, for example, for calibrating the electronic device for breath detection, for example, for use in a method according to some of the first or second aspects.

Using the method described the relation between the camera and user's head is obtained. PI-P7 show points in space which vary along the x, y, z axes, at which a device could be positioned relative to the user. The resolution of this spatial grid could be increased for more accuracy.

Additionally, the spatial map could also include variation in the relative orientation of the device to the user at each point (not shown). By comparing the magnitude of breath input obtained at each point for a known breath flow rate, a spatial map of the magnitude breath input can be created.

In some embodiments the electronic device measures the mic input at each point in space for a given flow rate, and compares the values to see how it varies at different positions.

Additionally, by measuring the breath input amplitude at a point in space, and comparing this to a value obtained with a formal measurement of spirometry or lung function, for example, via a wearable chest wall sensor or volumetric measurement via infrared camera, either contemporaneously or comparing two values, for example, (obtained with each method, for example, BIEUI vs gold standard) with a known breath flow rate, a calibration to real world spirometry values can be obtained using the BIEUI.

In some embodiments, comparing the microphone input to the breath input magnitude at a given point and comparing it with values obtained with a gold standard device, enables a comparison of the two to be obtained.

Some embodiments of the disclosed technology may comprise the following items:
Item 1. A computer-implemented method of providing input using a dynamic keyboard breath input enabled user interface, BIEUI, the method comprising an electronic device:
   causing a keyboard affordance arrangement of selectable affordances of the BIEUI, to be presented on a display, wherein each selectable affordance is associated with a functionality performed by the electronic device which is triggered if the affordance is selected;
   detecting a cursor movement to a selectable affordance in the affordance arrangement; detecting an breath input to the BIEUI;
   triggering, responsive to a determination that the detected breath input has been accepted by the BIEUI, a selection of that selectable affordance of the affordance arrangement, wherein the selection of that selectable affordance causes performance of the keyboard functionality associated with the affordance selection indicated by the cursor and updating of the displayed keyboard affordance arrangement to display changes in position of at least one affordance in the keyboard dependent at least in part on a probability of functionality associated with each changed at least one affordance following the functionality triggered by the selected affordance.
Item 2. The method of item 1, wherein updating the keyboard affordance arrangement changes a position of at least one affordance in the keyboard affordance arrangement displayed in the BIEUI.
Item 3. The method of item 1 or 2, wherein updating the keyboard affordance arrangement comprises causing at least one new affordance associated with a new functionality to be presented in the keyboard affordance arrangement displayed in the BIEUI.
Item 4. The method of any one of the previous items, wherein updating the keyboard affordance arrangement comprises removing at least one previously displayed affordance from the keyboard affordance arrangement displayed in the BIEUI.
Item 5. The method of item 4, at least one removed affordance comprises a different affordance from the selected affordance.
Item 6. The method of any one of items 1 to 5, wherein the functionality comprises causing a graphical element to be presented in a text input box of the BIEUI.
Item 7. The method of item 6, wherein the graphical element is one or more of:
   an alpha-numeric character;
   a word or phrase; an
   image;
   a symbol; and an
   emoji.
Item 8. The method of item 7, wherein the keyboard affordance arrangement comprises an arrangement of affordances indicating graphical elements, wherein each graphical element comprises one or more text characters and the functionality associated with the selection of an affordance comprises providing the selected text character as input to the text input field presented in the BIEUI.
Item 9. The method of item 8, wherein updating the keyboard affordance arrangement changes the text characters in the affordance arrangement.
Item 10. The method of item 9, wherein the updated keyboard affordance arrangement comprises affordances associated with text characters having a position in the keyboard affordance arrangement based on an estimated likelihood of each of their associated text characters following the previously selected text character displayed in the text input field.
Item 11. The method of item 10, wherein the position in the keyboard affordance arrangement is determined based on a relative position of the previously selected affordance and/or the cursor.
Item 12. The method of any one of items 8 to 11, wherein the affordances are arranged so that the most central affordance in the keyboard affordance arrangement is predicted to be the most likely text character.
Item 13. A method as claimed in any one of items 8 to 12, wherein other, less likely, text characters are presented for selection using affordances arranged around the most central affordance of the keyboard affordance arrangement.
Item 14. A method as claimed in any one of items 8 to 13, wherein the distance of a predicted next affordance from the current cursor location is dependent on the likelihood of the text character associated with that affordance following the previously selected character.
Item 15. A method as claimed in any previous one of items 8 to 14, wherein the affordances are arranged in a keyboard comprising at least one circular tier of affordances arranged around a central affordance, wherein the central affordance presents the most likely next text character for selection and the adjacent circular tier of the at least one circular tier presents a plurality of next most likely text characters.
Item 16. A method as claimed in item 15, wherein each circular tier is associated with a range of dynamically determined likelihoods of a next text character.
Item 17. A method as claimed in item 16, wherein the range of dynamically determined likelihoods is dynamically determined to always present a fixed number of affordances in at least the first tier of affordances around the central affordance of the keyboard affordance arrangement.
Item 18. A method as claimed in item 17, wherein a number of affordances in another, second, tier of affordances presented adjacent the first tier of affordances varies according to a number of text characters predicted to be the next input text character exceeding a threshold.
Item 19. Apparatus comprising memory, one or more processors, and computer program code stored in the memory, wherein the computer program code, when loaded from memory and executed by the one or more processors causes the apparatus to perform a method according to any one of items 1 to 18.
Item 20. A computer program comprising a set of machine executable instructions, which, when loaded and executed on apparatus according to claim 18 causes the apparatus to perform a method according to any one of items 1 to 18.

The above items may be combined with each other and with any of the other aspects and embodiments of the technology disclosed herein in any appropriate manner apparent to someone of ordinary skill in the art.

In the drawings and specification, there have been disclosed exemplary embodiments. However, many variations and modifications can be made to these embodiments. Accordingly, although specific terms are employed, they are used in a generic and descriptive sense only and not for purposes of limitation, the scope of the embodiments being defined by the following claims.

1. A computer-implemented method of breath input recognition, the method comprising at an electronic device:
displaying a breath input enabled user interface (BIEUI) on a display whilst in a breath input receiving state or operational mode;
detecting, using a camera, a position of a head of a user of relative to the camera;
determining, based on the detected position of the head of the user, if at least part of a face of the user is directed towards to the displayed BIEUI;
detecting an audio signal using the microphone;
determining if the detected audio signal is a breath input to the BIEUI based on the audio signal and the detected position of the head of the user;
extracting one or more facial characteristics from the face of the user;
providing a set of one or more parameters representing the one or more extracted facial characteristics to one or both of a breath input detector and breath controller; and
using one or more of the extracted one or more facial characteristics to calibrate the breath input and to provide a particular type or strength of user breath input to the one or both of the breath input detector and breath controller.

2. A method according to claim 1, wherein determining if the detected audio signal is a breath input to the BIEUI based on the audio signal and the detected position of the head of the user comprises:
determining one or more audio characteristics of an audio signal using the microphone; determining if the audio signal comprises a BIEUI candidate breath input based on one or more the detected audio characteristics and the detected position of the head of the user, wherein,
responsive to a determination that the detected audio signal comprises a BIEUI candidate breath input, the candidate breath input is provided as intentional breath input to the BIEUI; and
responsive to a determination that the detected audio signal does not comprise a BIEUI candidate breathe input, discarding the unacceptable candidate breath input and/or processing the microphone input as non-breath audio input.

3. A method according to claim 1, further comprising:
guiding a cursor or other movable selection indicator presented in the BIEUI to a selectable BIEUI affordance; and
confirming using breath input selection of the selectable BIEUI affordance.

4. A method according to claim 1, further comprising:
guiding a cursor or other movable selection indicator presented in the BIEUI to a selectable BIEUI affordance; and
confirming using breath input selection of the selectable BIEUI affordance, wherein the cursor is guided by tracking a position of the head of the user using at least the camera.

5. A method according to claim 1, further comprising:
guiding a cursor or other movable selection indicator presented in the BIEUI to a selectable BIEUI affordance; and
confirming using breath input selection of the selectable BIEUI affordance, wherein the cursor is guided by tracking a gaze position of the user using at least the camera.

6. A method according to claim 1, wherein determining, based on the detected position of the head of the user, if at least part of a face of the user is directed towards to the displayed BIEIUI comprises:
determining a location of the head relative to the display or camera; and
determining an orientation of a face of a user relative to the display or relative to the orientation of the electronic device.

7. A method according to claim 1, wherein determining if the detected audio signal is a breath input to the BIEUI based on the audio signal and the detected position of the head of the user comprises:
determining one or more audio characteristics of an audio signal using the microphone;
determining if the audio signal comprises a BIEUI candidate breath input based on one or more the detected audio characteristics and the detected position of the head of the user, wherein,
responsive to a determination that the detected audio signal comprises a BIEUI candidate breath input, the candidate breath input is provided as intentional breath input to the BIEUI;
responsive to a determination that the detected audio signal does not comprise a BIEUI candidate breathe input, discarding the unacceptable candidate breath input and/or processing the microphone input as non-breath audio input,
and wherein determining if the audio signal comprises a BIEUI candidate breath input based on one or more the detected audio characteristics and the detected position of the head of the user comprises:
determining a probability of breath input is higher than a breath detection threshold, wherein the breath detection threshold is based on detecting audible breath input and one or more of:
a detected head position being indicative of a user facing the display;
the position of the head being within a certain distance of the device; and
a mouth area of the user being above a threshold mouth area value.

8. A method according to claim 1, wherein determining if the detected audio signal is a breath input to the BIEUI based on the audio signal and the detected position of the head of the user comprises:
determining one or more audio characteristics of an audio signal using the microphone;
determining if the audio signal comprises a BIEUI candidate breath input based on one or more the detected audio characteristics and the detected position of the head of the user, wherein,
responsive to a determination that the detected audio signal comprises a BIEUI candidate breath input, the candidate breath input is provided as intentional breath input to the BIEUI; and
responsive to a determination that the detected audio signal does not comprise a BIEUI candidate breathe input, discarding the unacceptable candidate breath input and/or processing the microphone input as non-breath audio input,
and wherein determining if the audio signal comprises a BIEUI candidate breath input based on one or more the detected audio characteristics and the detected position of the head of the user comprises:
determining a probability of breath input is higher than a breath detection threshold, wherein the breath detection threshold is based on detecting audible breath input and one or more of:
a detected head position being indicative of a user facing the display;
the position of the head being within a certain distance of the device; and
a mouth area of the user being above a threshold mouth area value,
wherein the breath detection threshold is a calibrated threshold for the user based on a spatial mapping of audio using the camera and microphone which calibrates a detected characteristic of the audio signal to that of a spirometry value.

9. A method according to claim 1, wherein determining if the detected audio signal is a breath input to the BIEUI based on the audio signal and the detected position of the head of the user comprises:
determining one or more audio characteristics of an audio signal using the microphone; determining if the audio signal comprises a BIEUI candidate breath input based on one or more the detected audio characteristics and the detected position of the head of the user, wherein,
responsive to a determination that the detected audio signal comprises a BIEUI candidate breath input, the candidate breath input is provided as intentional breath input to the BIEUI; and
responsive to a determination that the detected audio signal does not comprise a BIEUI candidate breathe input, discarding the unacceptable candidate breath input and/or processing the microphone input as non-breath audio input,
wherein determining if a BIEUI candidate breath input is a BIEUI breath input is based at least in part of a magnitude of the detected audio signal, and wherein the method further comprises:
combining, using a multivariate model, the camera input and microphone input, wherein the distance and/or orientation of the face of the user from the displayed BIEUI determined from the camera input is used to adjust the magnitude of the audio signal detected by the microphone.

10. A method according to claim 1, wherein determining if the detected audio signal is a breath input to the BIEUI based on the audio signal and the detected position of the head of the user comprises:
determining one or more audio characteristics of an audio signal using the microphone; determining if the audio signal comprises a BIEUI candidate breath input based on one or more the detected audio characteristics and the detected position of the head of the user, wherein,
responsive to a determination that the detected audio signal comprises a BIEUI candidate breath input, the candidate breath input is provided as intentional breath input to the BIEUI;
responsive to a determination that the detected audio signal does not comprise a BIEUI candidate breathe input, discarding the unacceptable candidate breath input and/or processing the microphone input as non-breath audio input, and
wherein determining if a BIEUI candidate breath input is a BIEUI breath input is based at least in part on an area of a mouth of the user, and wherein the method further comprises:
determining one or more facial characteristics of the user; and
determining from the one or more facial characteristics a mouth area of the user;
wherein if the mouth area of the user is determined to be below a threshold value, the audio signal is determined to not correspond to intentional breath user input.

11. A method according to claim 1, wherein determining if the detected audio signal is a breath input to the BIEUI based on the audio signal and the detected position of the head of the user comprises:
determining one or more audio characteristics of an audio signal using the microphone; determining if the audio signal comprises a BIEUI candidate breath input based on one or more the detected audio characteristics and the detected position of the head of the user, wherein,
responsive to a determination that the detected audio signal comprises a BIEUI candidate breath input, the candidate breath input is provided as intentional breath input to the BIEUI;
responsive to a determination that the detected audio signal does not comprise a BIEUI candidate breathe input, discarding the unacceptable candidate breath input and/or processing the microphone input as non-breath audio input, and
wherein the method further comprises:
performing facial recognition of the detected face of the user to authenticate the user; and responsive to the facial recognition indicating a user is a non-authenticated user; and
determining the detected audio signal is a breath input from an unauthenticated user and comprises unacceptable intentional breath input to the BIEUI.

12. A method according to claim 1, wherein the method further comprises:
displaying an image of the face of the user concurrent with detecting an audio signal using the microphone; and
displaying an overlay of augmented reality elements on the display to guide the user to change one or more of:
a distance of the face of the user from the microphone; a position and/or orientation of the head of the user affecting a direction of breath from the user;
a device orientation relative to gravity or relative to the orientation of the head of the user; and
one of more characteristics of at least a part of the head of the user affecting a magnitude of the detected breath signal from the user.

13. A method according to claim 1, wherein the electronic device enters the breath input receiving state responsive to detecting a triggering breath input to a BIEUI.

14. A computer-implemented method according to claim 1, wherein the method further comprises training a user to provide breath input acceptable by the breath input enabled user interface, BIEUI, of the electronic device by:
displaying a breath input training BIEUI;
detecting audio input;
determining one or more characteristics of the detected audio input;
determining a conformance of one or more characteristics of the detected audio input with corresponding one or more characteristics of a predetermined type of intentional breath input to the breath input training BIEUI; and
causing at least one visual indicator of the conformance to be presented in the breath input training BIEUI.

15. A method according to claim 1, wherein the method further comprises training a user to provide breath input acceptable by the breath input enabled user interface, BIEUI, on the electronic device by:
displaying a breath input training BIEUI;
detecting audio input;
determining one or more characteristics of the detected audio input;
determining a conformance of one or more characteristics of the detected audio input with corresponding one or more characteristics of a predetermined type of intentional breath input to the breath input training BIEUI; and
causing at least one visual indicator of the conformance to be presented in the breath input training BIEUI,
wherein audio input which fails to conform with the one or more characteristics of the predetermined type of intentional breath input to the BIEUI is processed to remove unintentional breath input to the BIEUI, and wherein audio input which conforms with the one or more characteristics of the predetermined type of intentional breath input to the BIEUI is provided as breath input to the BIEUI.

16. (canceled)

17. A method according to claim 1, wherein the method further comprises training a user to provide breath input acceptable by the breath input enabled user interface, BIEUI, of the electronic device by:
displaying a breath input training BIEUI;
detecting audio input;
determining one or more characteristics of the detected audio input;
determining a conformance of one or more characteristics of the detected audio input with corresponding one or more characteristics of a predetermined type of intentional breath input to the breath input training BIEUI; and
causing at least one visual indicator of the conformance to be presented in the breath input training BIEUI,
wherein the at least one visual indicator of the conformance comprises causing presentation of an animated graphic, or UI element, comprising one or a combination of one or more of the following, either sequentially or as a combination:
tracing a shape outline on the display, wherein the direction and speed at which the shape outline is traced is determined in real-time based on a score indicative of the conformance; filling a shape outline presenting on the display, wherein the speed at which the shape outline is filled is determined in real-time based on a score indicative of the conformance; and modifying at least one dynamic background graphical element, wherein one or more visual characteristics of a dynamic background graphical element is altered based on a score indicative of the conformance,
wherein the score is dependent on at least the detected magnitude of the audio input.

18. A method according to claim 1, wherein the method further comprises training a user to provide breath input acceptable by the breath input enabled user interface, BIEUI, of the electronic device by:
displaying a breath input training BIEUI;
detecting audio input;
determining one or more characteristics of the detected audio input;
determining a conformance of one or more characteristics of the detected audio input with corresponding one or more characteristics of a predetermined type of intentional breath input to the breath input training BIEUI; and
causing at least one visual indicator of the conformance to be presented in the breath input training BIEUI,
wherein the electronic device is configured guide a user to position their head for optimal breath detection, and the method further comprises:
providing a visual indicator in a user interface of the electronic device to guide the user to align a yaw and pitch of that user's face to orientate that user's mouth towards a location of a microphone or other breath sensing element(s) of the electronic device.

19. A method according to claim 1, wherein the method further comprises training a user to provide breath input acceptable by the breath input enabled user interface, BIEUI, of the electronic device by:
displaying a breath input training BIEUI;
detecting audio input;
determining one or more characteristics of the detected audio input;
determining a conformance of one or more characteristics of the detected audio input with corresponding one or more characteristics of a predetermined type of intentional breath input to the breath input training BIEUI; and
causing at least one visual indicator of the conformance to be presented in the breath input training BIEUI,
wherein the electronic device is configured to guide a user to position their head for optimal breath detection, and the method further comprises:
providing a visual indicator in a user interface of the electronic device to guide the user to position their head at a distance or within a range of distances from the device, wherein the user interface is a breath input enabled user interface, BIEUI.

20. (canceled)

21. (canceled)

22. Apparatus comprising memory, a processor, and computer program code stored in the memory, wherein the computer program code, when loaded from memory and executed by the one or more processors causes the apparatus to perform a computer-implemented method of breath input recognition, the method comprising an electronic device:
displaying a breath input enabled user interface, BIEUI on a display whilst in a breath input receiving state or operational mode;
detecting, using a camera, a position of a head of a user of relative to the camera;
determining, based on the detected position of the head of the user, if at least part of a face of the user is directed towards to the displayed BIEUI;
detecting an audio signal using the microphone;
determining if the detected audio signal is a breath input to the BIEUI based on the audio signal and the detected position of the head of the user,
extracting one or more facial characteristics from the face of the user;
provide a set of one or more parameters representing the one or more extracted facial characteristics to one or both of a breath input detector and breath controller; and
using one or more of the extracted one or more facial characteristics to calibrate the breath input and to provide a particular type or strength of user breath input to the one or both of the breath input detector and breath controller.

23. (canceled)

24. A computer program comprising a set of machine executable instructions, which, when loaded and executed on apparatus causes the apparatus to perform a computer-implemented method of breath input recognition, the method comprising an electronic device:
displaying a breath input enabled user interface, BIEUI on a display whilst in a breath input receiving state or operational mode;
detecting, using a camera, a position of a head of a user of relative to the camera;
determining, based on the detected position of the head of the user, if at least part of a face of the user is directed towards to the displayed BIEUI;
detecting an audio signal using the microphone;
determining if the detected audio signal is a breath input to the BIEUI based on the audio signal and the detected position of the head of the user,
extracting one or more facial characteristics from the face of the user;
provide a set of one or more parameters representing the one or more extracted facial characteristics to one or both of a breath input detector and breath controller; and
using one or more of the extracted one or more facial characteristics to calibrate the breath input and to provide a particular type or strength of user breath input to the one or both of the breath input detector and breath controller.

25. (canceled)
